(19) United States
(12) Patent Application Publication
(10) Pub. No.: US 2017/0056834 A1
(43) Pub. Date: Mar. 2, 2017

(54) MULTILAYER COATINGS AND METHODS OF MAKING AND USING THEREOF

(71) Applicant: Ohio State Innovation Foundation, Columbus, OH (US)

(72) Inventors: Bharat Bhushan, Powell, OH (US); Philip Simon Brown, Columbus, OH (US)

(21) Appl. No.: 14/833,692

(22) Filed: Aug. 24, 2015

(51) Int. Cl. B01D 69/02; C09D 139/04; C08K 3/36; B05D 7/00

(52) U.S. Cl. CPC B01D 69/02; B05D 7/52; C09D 139/04; C08K 3/36

(57) ABSTRACT

Multilayer coatings, articles comprising multilayer coatings, and methods of making and using thereof are described herein. The multilayer coating can contain two or more oppositely charged alternating layers, comprising at least one fixed layer comprising a first polymer and at least one inorganic layer comprising a plurality of particles, wherein the inorganic layer forms a surface of the two or more oppositely charged alternating layers. The multilayer coating can further contain an adhesion layer disposed on the at least one inorganic layer, the adhesion layer comprising a second polymer having a charge opposite that of the plurality of particles. The multilayer coating can also contain a functional layer disposed on the adhesion layer, wherein the functional layer forms a surface of the multilayer coating. In some embodiments, the coatings can separate a liquid mixture comprising a polar liquid and a non-polar liquid.

### BACKGROUND OF THE DISCLOSURE

The surface properties of a coating, with regards to wetting by liquids, are determined by the chemistry and topography at the interface. By selecting the correct chemistry and topography, a coating can display a variety of liquid wetting properties. These properties can be exploited for a variety of applications. For instance, coatings that repel water (hydrophobic) are useful for self-cleaning applications. In nature, this is most evident in the lotus leaf (Barthlott, et al., 1997, Planta, 202, 1-8); the superhydrophobic properties of the leaf surface, achieved through the presence of hierarchical structure created by rough papillae and superimposed with hydrophobic wax nanotubules, cause water droplets to roll around the surface of the leaf, collecting contaminants as they go thus keeping the leaf clean (Barthlott, et al.). Coatings that attract water (hydrophilic) are useful for anti-fogging applications (Grosu, et al., 2004, J. Phys. D, 37, 3350-3355). Coatings with surface tensions lower than that of water (72 mN m⁻¹) but higher than that of oils (20-30 mN m⁻¹) can attract oils (oleophilic) but repel water and can be used to create oil-water separators (Feng, et al., 2004, Angew. Chem., Int. Ed., 43, 2012-2014; Wang, et al., 2010, ACS Appl. Mater. Interfaces, 2, 677-683). In addition, their water repellency also makes them ideal for self-cleaning (Bhushan, B., 2012, Biomimetics: Bioinspired Hierarchical-Structured Surfaces for Green Science and Technology, Springer-Verlag, Heidelberg, Germany; Bixler, et al., 2015, Crit. Rev. Solid State Mat. Sci., 40, 1-37) and anti-icing (Cao, et al., 2009, Langmuir, 25, 12444-12448) applications. Coatings with lower surface tensions (˜20 mN m⁻¹ or less) will repel both oil (oleophobic) and water and are useful for anti-fouling such as in medical and transport applications, where both the oil-repellency and nanostructuring are of importance (Hsieh, et al., 2005, Appl. Surf Sci., 240, 318-326; Tuteja, et al., 2007, Science, 318, 1618-1622; Jung, et al., 2009, Langmuir, 25, 14165-14173).

There are various existing methods for fabrication of coatings with different surface properties. In general, a “one-pot” technique where all the materials are mixed and deposited together is used. Such a technique can lead to a coating with poor durability as the (typically low surface tension) material used to achieve the desired surface properties is distributed throughout the coating. In addition, each surface property requires different materials and methods.

There remains a need in the art for coatings having improved properties, including desirable surface properties combined with durability, as well as improved methods of making such coatings.

### SUMMARY OF THE DISCLOSURE

Provided are multilayer coatings, articles comprising the multilayer coatings described herein, and methods of making and using thereof. The multilayer coatings can comprise a plurality of layers disposed on top of one another, so as to form a multilayer coating. The plurality of layers making up the multilayer coating can have alternating charges, meaning that each layer within the multilayer coating can have a charge opposite to the charge of the layer on which it is disposed.

The multilayer coatings can comprise two or more base layers, an adhesion layer comprising a charged polymer disposed on the two or more base layers, and a functional layer disposed on the adhesion layer, wherein the functional layer forms a surface of the multilayer coating. The two or more base layers can comprise a fixed layer comprising a charged polymer and an inorganic layer comprising a plurality of particles having a charge. The two or more base layers can optionally further include one or more additional charged layers (e.g., one or more additional layers formed from a charged polymer, one or more additional layers comprising a plurality of charged particles, or a combination thereof). In certain embodiments, the adhesion layer can be disposed on the inorganic layer (i.e., the inorganic layer can be the top layer of the two or more base layers present in the multilayer coating). The fixed layer can comprise a first polymer having a charge and the adhesion layer can comprise a second polymer having a charge. In some embodiments, the first polymer can have a charge opposite that of the plurality of particles, the second polymer can have a charge opposite that of the plurality of particles, or both the first polymer and the second polymer can have a charge opposite that of the plurality of particles.

In one embodiment, the multilayer coating can comprise a fixed layer comprising a first polymer having a charge; an inorganic layer disposed on the fixed layer, the inorganic layer comprising a plurality of particles having a charge opposite that of the first polymer; an adhesion layer disposed on the inorganic layer, the adhesion layer comprising a second polymer having a charge opposite that of the plurality of particles; and a functional layer disposed on the adhesion layer, wherein the functional layer forms a surface of the multilayer coating. The fixed layer can be disposed on a substrate.

In certain embodiments, the charge density of the charged polymers that form layers of the multilayer coatings (e.g., the first polymer and the second polymer) can independently be at least about 0.5 meq/g, such as from about 1.0 to about 20 meq/g, or from about 1.5 to about 10 meq/g. In certain embodiments, the weight average molecular weight of the charged polymers that form layers of the multilayer coatings (e.g., the first polymer and the second polymer) can independently be from about 50,000 to about 1,000,000 Da, such as from about 100,000 to about 200,000 Da. In one embodiment, both the first polymer and the second polymer can be cationic polymers. For example, in some cases, both the first polymer and the second polymer can independently be selected from unsubstituted and unsubstituted quaternary ammonium polymers, cationically modified polysaccharides, cationically modified (meth)acrylamide polymers, cationically modified (meth)acrylate polymers, chitosan, quaternized vinylimidazole polymers, polyalkylammonium polymers, polyalkyleneimine based polymers, copolymers thereof, blends thereof, and derivatives thereof. In some examples, the first polymer and the second polymer can include polydiallyldimethylammonium.

The particles in the inorganic layer can have any suitable charge. In some embodiments, the plurality of particles in the inorganic layer can comprise a plurality of anionic particles. In some embodiments, the plurality of particles in the inorganic layer can comprise a blend of particles having different shapes or sizes. In certain embodiments, the plurality of particles in the inorganic layer can comprise a plurality of nanoparticles (e.g., a plurality of spherical nanoparticles, a plurality of nanotubes, or a combination thereof). The plurality of nanoparticles can have an average particle size of from about 1 nm to about 200 nm (e.g., from about 1 nm to about 50 nm). Examples of suitable particles include alkaline earth metal oxide nanoparticles, transition metal oxide nanoparticles, lanthanide metal oxide nanoparticles, group IVA oxide nanoparticles, transition metal nanoparticles, transition-metal catalyst nanoparticles, metal alloy nanoparticles, silicate nanoparticles, alumino-silicate nanoparticles, clays, and combinations thereof. In some examples, the plurality of particles can include silicon dioxide.

The functional layer can be uniformly distributed across the adhesive layer. Alternatively, the functional layer can be patterned. For example, the functional layer can be present at some points on the adhesive layer and absent at others, such that the material forming the functional layer is present at some points on the surface of the multilayer coating while the material forming the adhesion layer is present at other points on the surface of the multilayer. In other cases, the functional layer can be patterned such that the composition of the functional layer varies at different points on the adhesive layer, such that a first material is present at some points on the surface of the multilayer coating and a second material is present at some points on the surface of the multilayer coating. When the functional layer is patterned, the pattern of the functional layer can be random or ordered.

In certain embodiments, the functional layer can comprise a superoleophilic material, a superoleophobic material, a superhydrophobic material, a superhydrophilic material, or combinations thereof. In some cases, the functional layer can comprise a charged material (e.g., a cationic material or an anionic material). In some of these embodiments, the functional layer can comprise a charged material that has a charge opposite that of the second polymer. In some cases, the functional layer can comprise an uncharged material. In some of these embodiments, the functional layer can be covalently bonded to the adhesion layer.

The functional layer can comprise a polymer or a small molecule (e.g., a compound having a molecular weight of less than about 900 Da). In some examples, the functional layer can comprise a halogenated silane. In some examples, the functional layer can comprise a fluorosurfactant. In some examples, when the first polymer and the second polymer consist of polydiallyldimethylammonium and the plurality of particles consist of silicon dioxide nanoparticles, the functional layer is not a fluorosurfactant. In some examples, when the first polymer and the second polymer consist of polydiallyldimethylammonium and the plurality of particles consist of silicon dioxide nanoparticles, the functional layer is not negatively charged.

In some cases, the plurality of layers making up the multilayer coating can be non-covalently bonded together. In one embodiment, the fixed layer, the inorganic layer, and the adhesion layer of the multilayer coating can be bonded together by electrostatic force, dipole-dipole interactions, hydrogen bonding, or a combination thereof, and the functional layer can be covalently bonded to the adhesion layer. In one embodiment, the fixed layer, the inorganic layer, the adhesion layer, and the functional layer of the multilayer coating can be bonded together by electrostatic force, dipole-dipole interactions, hydrogen bonding, or a combination thereof.

The multilayer coating can have a thickness of from about 100 nm to about 2 microns (e.g., from about 100 nm to about 800 nm). In some embodiments, the fixed layer can have a thickness of from about 50 nm to about 400 nm, such as from about 150 nm to about 250 nm. In some embodiments, the inorganic layer can have a thickness of from about 50 nm to about 800 nm, such as from about 250 nm to about 450 nm. In some embodiment, the adhesion layer can have a thickness of from about 5 nm to 250 nm. In some embodiment, the functional layer can have a thickness of about 100 nm or less (e.g., from about 5 nm to about 100 nm).

The multilayer coatings described herein can exhibit desirable surface properties. In some cases, the surface of the multilayer coating can exhibit a water contact angle of at least about 150° and a hexadecane contact angle of at least about 150°. In some embodiments, the surface of the multilayer coating can exhibit a water contact angle of less than about 10° and a hexadecane contact angle of at least about 150°. In some embodiments, the surface of the multilayer coating can exhibit a water contact angle of less than about 10° and a hexadecane contact angle of less than about10°. In some embodiments, the surface of the multilayer coating can exhibit a tilt angle of about 10° or less, such as from about 2° to about 10°.

Methods of forming the multilayer coatings described herein are also disclosed. In some embodiments, the method can include depositing two or more base layers having alternating charge on a surface of the substrate, the two or more base layers comprising a fixed layer and an inorganic layer. For example, the method can include depositing a first charged polymer on a surface of the substrate to form a fixed layer disposed on the substrate, and depositing a plurality of charged particles on the fixed layer to form an inorganic layer disposed on the fixed layer. The charged particles can have a charge opposite of the first charged polymer. Methods can further include depositing a second charged polymer on the two or more base layers (e.g., on the inorganic layer) to form an adhesion layer disposed on the two or more base layers, and depositing a functional material on the adhesion layer to form a functional layer disposed on the adhesion layer.

The plurality of layers forming the multilayer coating (e.g., the fixed layer, the inorganic layer, the adhesion layer, and the functional layer) can be independently deposited using any suitable method, such as film casting, spin coating, dip coating, spray coating, flow coating, layer-by-layer coating, vapor deposition, knife casting, film casting, vacuum-assisted dip-deposition, plasma deposition, or a combination thereof. In some embodiments, the substrate can be wholly or partially coated with the multilayer coating. In some cases, methods can further involve treating the substrate (e.g., etching the substrate, chemically treating the substrate, roughening the substrate, etc.) to improve adhesion of the multilayer coating.

Also provided are articles comprising the multilayer coatings described herein. In one example, the article can be a mesh comprising a multilayer coating described herein disposed on a surface of the mesh. Such articles can be used to separate liquid mixtures comprising a polar liquid and a non-polar liquid (e.g., water and oil). Accordingly, also provided are methods for separating a liquid mixture comprising a polar liquid and a non-polar liquid. Such methods can include contacting an article (e.g., a mesh) comprising the multilayer coating with the liquid mixture under conditions effective to afford permeation of the polar liquid or the non-polar liquid through the article.

### BRIEF DESCRIPTION OF THE DRAWINGS

FIG. 1 is a schematic diagram of “flip-flop” vs “non-flip-flop” surface properties. For the “flip-flop” coating, water is able to penetrate down through the repellent surfactant tails of the functional layer (fluorosurfactant) to the high surface tension portion of the coating while the bulky oil molecules are repelled. For non-flip-flop coatings, water is unable to penetrate the functional layer (fluorosilane).

FIG. 2 is a schematic diagram of the four layer-by-layer composite coatings. Each layer is deposited separately. Also shown are the chemical composition and charge of each layer. The functional layer (FL) is deposited last and helps to provide the desired surface chemistry.

FIG. 3 is a diagram showing water and hexadecane droplets (5 μL) deposited on the four layer-by-layer composite coatings.

FIG. 4 shows surface height maps and sample surface profiles (locations indicated by arrows) before and after Atomic Force Microscopy (AFM) wear experiment with 15 μm radius borosilicate ball at a load of 10 μN for flat and superhydrophilic/superoleophobic layer-by-layer composite coatings left, panel (a)), and optical micrographs before and after wear experiments using ball-on-flat tribometer at 10 mN for flat and hydrophilic/oleophobic layer-by-layer composite coatings (right, panel (b)). Similar results were obtained for the three remaining layer-by-layer composite coatings. RMS roughness values are displayed.

FIG. 5 shows photographs of flat and superhydrophilic/superoleophobic layer-by-layer composite coatings. The flat coating appears transparent. Reduction in transparency for the composite coating compared to the flat coating was attributed to the NP and FL layers.

FIG. 6 shows photographs of the four layer-by-layer composite coatings after exposure to water vapor. The hydrophilic coatings maintain transparency and formed a thin water film on the surface. The hydrophobic coatings become opaque and formed discrete water droplets on the surface.

FIG. 7 shows photographs of the four layer-by-layer composite coatings after freezing and deposition of supercooled water. The water immediately froze upon contact with the hydrophilic coatings whilst the droplets were able to roll off the hydrophobic coatings before freezing.

FIG. 8 shows optical micrographs of contaminated coatings before and after self-cleaning test on flat and the superhydrophobic layer-by-layer composite coatings. Dark spots on coatings and cloth indicate silicon carbide particle contaminants. Image analysis suggests a >90% removal of particles on the two composite coatings.

FIG. 9 shows optical micrographs of contaminated coatings and oil-impregnated microfiber cloth before and after smudge test on flat and the superoleophobic layer-by-layer composite coatings. Dark spots on coatings and cloth indicate silicon carbide particle contaminants.

FIG. 10 shows photographs of the hydrophobic/oleophilic and hydrophilic/oleophobic layer-by-layer composite coated stainless steel meshes acting as oil-water separators. On the superhydrophobic/superoleophilic coated mesh, water collects on top of the mesh whilst oil passes through. In contrast, on the superhydrophilic/superoleophobic coated mesh, water passes through the mesh while the oil remains on the top surface. Alternatively the meshes can be placed at an angle and oil and water collected simultaneously in separate beakers. Oil and water dyes used to enhance contrast.

FIG. 11 shows optical micrographs before and after wear experiments using ball-on-flat tribometer at 10 mN for “one-pot” and layer-by-layer coatings.

### DETAILED DESCRIPTION

Provided are multilayer coatings, articles comprising the multilayer coatings described herein, and methods of making and using thereof. The multilayer coatings can comprise a plurality of layers disposed on top of one another, so as to form a multilayer coating. The plurality of layers making up the multilayer coating can have alternating charges, meaning that each layer within the multilayer coating can have a charge opposite to the charge of the layer on which it is disposed.

The charged layers of the multilayer coating can be formed from any suitably charged material. “Charged material” as used herein, refers to a material having a cationic or anionic charge, including “pseudo-cationic” and “pseudo-anionic” charged materials.

The terms “pseudo-cationic” and “pseudo-anionic” refer to materials that do not possesses an inherent positive or negative charge, but do possess behavior similar to charged materials. The pseudo-charged behavior may arise in these materials due to electron donating or electron receiving atoms and/or groups within the material. In some embodiments, charged layers can be independently formed from an organic material,an inorganic material, or a combination thereof. For example, charged layers can be independently formed from a polymer, a small molecule, a particle, or a combination thereof.

The multilayer coatings can comprise two or more base layers, an adhesion layer comprising a charged polymer disposed on the two or more base layers, and a functional layer disposed on the adhesion layer, wherein the functional layer forms a surface of the multilayer coating.

The two or more base layers can comprise a fixed layer comprising a charged polymer and an inorganic layer comprising a plurality of particles having a charge. The two or more base layers can optionally further include one or more additional charged layers (e.g., one or more additional layers formed from a charged polymer, one or more additional layers comprising a plurality of charged particles, or a combination thereof). The two or more base layers can include any number of additional layers, such that the multilayer coating can comprise from 2 to 100 base layers, (for e.g., 3 base layers or more, 4 base layers or more, 5 base layers or more, 6 base layers or more, 8 base layers or more, 10 base layers or more, 20 base layers or more, or 50 base layers or more). In some cases, the two or more base layers can include from 1 to 8 additional layers (e.g., from 1 to 3 additional layers), such that the multilayer coating can comprise from 3 to 10 base layers (or from 3 to 5 base layers).

In certain embodiments, the adhesion layer can be disposed on the inorganic layer (i.e., the inorganic layer can be the top layer of the two or more base layers present in the multilayer coating). The fixed layer can comprise a first polymer having a charge and the adhesion layer can comprise a second polymer having a charge. In some embodiments, the first polymer can have a charge opposite that of the plurality of particles, the second polymer can have a charge opposite that of the plurality of particles, or both the first polymer and the second polymer can have a charge opposite that of the plurality of particles.

In certain embodiments, the fixed layer can be disposed on a substrate. The substrate can be formed from any material known in the art, such as plastics, glass, fiberglass, ceramic, metals, fused silica, and woven or non-woven fabrics. The substrate can be in any configuration configured to facilitate formation of a coating suitable for use in a particular application. For example, the substrate can be flat, have a cylindrical cross-section, or oval cross-section. In certain embodiments, the substrate can be a liquid-permeable material, such as a mesh or porous solid.

The fixed layer can include any suitably charged material. The charged material in the fixed layer can be chosen based on the substrate on which the coating is disposed. For example, the fixed layer can include a positively charged material if the substrate is negatively charged and/or the substrate can interact with the positively charged material. In some embodiments, the fixed layer and the substrate can be bonded together by electrostatic force, dipole-dipole interactions, hydrogen bonding, or combinations thereof. The fixed layer can also be covalently bonded to the substrate.

In some embodiments, the fixed layer can include a first polymer having a positive or negative charge. In certain examples, the fixed layer can include a first polymer having a positive charge. The first polymer can be a natural or synthetic polymer. The first polymer can be a homopolymer or a copolymer comprising two or more monomers. The copolymer can be random, block, or comprise a combination of random and block sequences. The first polymer can in some embodiments be linear polymers, branched polymers, or hyperbranched/dendritic polymers. The first polymer can also be present as a crosslinked polymer.

The first polymer can have a charge density of about 0.5 meq/g or greater at a pH of 7.0. For example, the first polymer can have a charge density of about 1 meq/g or greater, about 1.5 meq/g or greater, about 2 meq/g or greater, about 2.5 meq/g or greater, about 3 meq/g or greater, about 3.5 meq/g or greater, or about 4 meq/g or greater at a pH of 7.0. In some embodiments, the first polymer can have a charge density of about 1 meq/g to about 20 meq/g (e.g., about 1.5 meq/g to about 20 meq/g, about 2 meq/g to about 20 meq/g, about 1 meq/g to about 10 meq/g, about 1.5 meq/g to about 10 meq/a, or about 2 meq/g to about 10 meq/g) at a pH of 7.0.

The first polymer can have a weight average molecular weight of from about 10,000 Da or greater. For example, the first polymer can have a weight average molecular weight of from about 25,000 Da or greater, about 50,000 Da or greater, about 75,000 Da or greater, about or 100,000 Da or greater. In some embodiments, the first polymer can have a weight average molecular weight of about 25,000 Da to about 1,000,000 Da (e.g., about 50,000 Da to about 500,000 Da, about 50,000 Da to about 250,000 Da, about 100,000 Da to about 250,000 Da, or 100,000 Da to about 200,000 Da).

The first polymer can have a number average molecular weight of from about 10,000 Da or greater. For example, the first polymer can have a number average molecular weight of from about 25,000 Da or greater, about 50,000 Da or greater, about 75,000 Da or greater, about or 100,000 Da or greater. In some embodiments, the first polymer can have a number average molecular weight of about 25,000 Da to about 1,000,000 Da (e.g., about 50,000 Da to about 500,000 Da, about 50,000 Da to about 250,000 Da, about 100,000 Da to about 250,000 Da, or 100,000 Da to about 200,000 Da),

In certain examples, the first polymer can be a cationic polymer. Examples of suitable cationic polymers include substituted and unsubstituted quaternary ammonium polymers; quatemized vinylimidazole polymers; dialkylimidazolium; poly(acrytic acid);

polystyrenesulfonates; cationically or anionically modified polymers of polysaccharides, poly(meth)acrylamide, poly(meth)acrylate, chitosan, polyalkyleneimines, polyamidoamines, polyepihydrin, polyamines; polyvinyl-heterocycles; N-vinyl lactams; copolymers thereof, and blends thereof.

In certain examples, the first polymer can be an anionic polymer. Suitable anionic polymers can include an anionic moiety, such as a sulfonate, sulfate, borate, carboxylate, phosphonate, phosphate, thioacetate, thiols, thiosulphate, oxalate, nitro, alkoxide, or combinations thereof. Examples of suitable anionic polymers or polymers that can be modified to contain an anionic group can include polyesters, poly(meth)acrylates, polyacrylic acids, polysulfonates, polysaccharides, polycarboxylates, polyphosphonate, polyphosphonite, polysiloxanes, polyurethanes, polythioethers, polycarbonates, polyarylalkylenes, polyalkylenes, polysilanes, polyesteramides, polyacetal, polysulfones, polystyrenes, polyacrylamides, polyvinyl alcohols, derivatives thereof, copolymers thereof, and blends thereof.

In certain examples, the fixed layer can include polyethyleneimine, polyvinylamines, polyallylamines, polyetheramines, polyvinylamine, poly-N-isopropylallylamine, poly-N-tert-butylallylamine, poly-N-1,2-dimethylpropylallylamine, poly-N-methylallylamine, poly-N,N-dimethylallylamine, polyalkylammonium, poly(lactic-co-glycolic acid), polydiallyldiethyl ammonium compounds, diallyldimethyl ammonium compounds, polyvinylbenzonyltrimethylammonium chloride, (polymethacryloyloxy)ethyl-trimethylammonitim chloride, 1-ethyl-3-methylimidazolium, [(methacryloyloxy)ethyl]trimethyl ammonium compounds, [(methacrylamido)propyl]ltrimethyl ammonium compounds, [(acryloyloxy)]ethyl]trimethyl ammonium compounds, (acrylamidomethylpropyl)trimethyl ammonium compounds, [(acrylamide)methyl]butyl trimethyl ammonium compounds, poly-2-vinylpiperidine, poly-4-vinylpiperidine, polyaminostyrene, derivatives thereof, copolymers thereof, and blends thereof. In some embodiments, the first polymer can include a polydialkyldiallylammonium compound such as polydimethyldiallylatnmonium.

The inorganic layer can include any suitable material. The material in the inorganic layer can be chosen based on its interaction with the layer on which it is disposed. For example, in one embodiment, the inorganic layer can be disposed on the fixed layer, the fixed layer can be positively charged, and the inorganic layer can be negatively charged. In some embodiments, the inorganic layer and the fixed layer can be bonded together by electrostatic force, dipole-dipole interactions, hydrogen bonding, or combinations thereof.

The inorganic layer can comprise a plurality of particles. The size and shape of the plurality of particles can vary. In some embodiments, the plurality of particles can include particles having an average particle size of less than 1 micron. In some embodiments, the plurality of particles can include spherical particles, non-spherical particles (such as elongated particles, cylindrical particles, rod-like particles, or any irregularly shaped particles), or combinations thereof. In certain embodiments, the plurality of particles can include nanostructures including nanoparticles, nanotubes, nanoclusters, nanowires, or combinations thereof.

In some embodiments, the plurality of particles can have an average particle size of less than about 1 micron (e.g., less than about 750 microns, less than about 500 microns, less than about 250 microns, less than about 200 microns, less than about 150 microns, less than about 100 microns, less than about 50 microns, or less than about 25 microns. In some embodiments, the plurality of particles can have an average particle size of at least about 1 nm (e.g., at least about 5 nm, at least about 10 nm, at least about 15 nm, or at least about 25 nm). The plurality of particles can have an average particle size ranging from any of the minimum values described above to any of the maximum values described above. For example, in certain embodiments, the plurality of particles can have an average particle size of from about 1 nm to about 200 nm (e.g., from about 1 nm to about 150 nm, from about 1 nm to about 150 nm, from about 1 nm to about 100 nm, or from about 1 nm to about 50 nm).

The term “average particle size,” as used herein, generally refers to the statistical mean particle size (diameter) of the particles in a population of particles. The diameter of an essentially spherical particle may refer to the physical or hydrodynamic diameter. The diameter of a non-spherical particle may refer preferentially to the hydrodynamic diameter. As used herein, the diameter of an irregularly-shaped particle may refer to the largest linear distance between two points on the surface of the particle. As used herein, the diameter of the elongated particles, nanotubes, rod-like particles, or cylindrical particles may refer to the largest linear distance between two points on the horizontal cross-section of the particle. The mean particle size can be measured using methods known in the art, such as by dynamic light scattering or electron microscopy.

In the cases of non-spherical (e.g., rod-like particles), the plurality of particles can have an average particle length of about 10 nm or greater. For example, the plurality of particles can have an average particle length of about 50 nm or greater, about 100 nm or greater, about 200 nm or greater, about 500 nm or greater, about 1 nm or greater, about 2 nm or greater, about 3 nm or greater, about 4 nm or greater, or about 5 nm or greater.

Non-spherical particles (e.g., rod-like particles) can also be described by their aspect ratio. In some embodiments, the plurality of particles in the inorganic layer can have an average aspect ratio of length to diameter of from about 2:1 to about 250:1.

The plurality of particles in the inorganic layer can be monodisperse in size. The term “monodisperse,” as used herein, describes a population of particles where all of the particles are the same or nearly the same size. As used herein, a monodisperse particle size distribution refers to particle distributions in which 80% of the distribution (e.g., 85% of the distribution, 90% of the distribution, or 95% of the distribution) lies within 20% of the median particle size (e.g., within 15% of the median particle size, within 10% of the median particle size, or within 5% of the median particle size). In other examples, the inorganic layer can include particles of varying sized (e.g., a mixture of two or more populations of particles having different average particle sizes).

The plurality of particles can be positively charged or negatively charged. In some embodiments, the plurality of particles can include alkaline earth metal oxide particles, transition metal oxide particles, lanthanide metal oxide particles, group IVA metal oxide particles, transition metal particles, transition-metal catalyst particles, particles comprising a transition metal adsorbed on a non-reactive support, metal alloy particles, silicate particles, alumino-silicate particles, particles comprising clays, and combinations thereof. In some examples, the inorganic layer comprises a plurality of silicon dioxide nanoparticles.

The multilayer coating can further include an adhesion layer disposed on the two or more base layers. In some embodiments, the adhesion layer can be disposed on the inorganic layer (e.g., the inorganic layer can be the top base layer).

The adhesion layer can include any suitably charged material. The charged material in the adhesion layer can be selected to interact with the inorganic layer. In some embodiments, the adhesion layer can include a second polymer. The second polymer can be positively charged or negatively charge. in some examples, the second polymer is positively charge at a pH of 7.0. The charge density of the second polymer can be about 0.5 meq/g or greater. For example, the charge density of the second polymer can be about 1 meq/g or greater, about 1.5 meq/g or greater, about 2 meq/q or greater, about 2.5 meq/q or greater, about 3 meq/g or greater, about 3.5 meq/g or greater, or about 4 meq/g or greater at a pH of 7.0. In some embodiments, the second polymer can have a charge density of about 1 meq/g to about 20 meq/g (e.g., about 1.5 meq/g to about 20 meq/g, about 2 meq/g to about 20 meq/g, about 1 meq/g to about 10 meq/g, about 1.5 meq/g to about 10 meq/g, or about 2 meq/g to about 10 meq/g) at a pH of 7.0.

The second polymer can have a weight average molecular weight of from about 10,000 Da or greater. For example, the weight average molecular weight of the second polymer can be about 25,000 Da or greater, about 50,000 Da or greater, about 75,000 Da or greater, about or 100,000 Da or greater. In some embodiments, the second polymer can have a weight average molecular weight of about 25,000 Da to about 1,000,000 Da (e.g., about 50,000 Da to about 500,000 Da, about 50,000 Da to about 250,000 Da, about 100,000 Da to about 250,000 Da, or 100,000 Da to about 200,000 Da).

In certain examples, the second polymer can be a cationic polymer. Examples of suitable cationic polymers include substituted and unsubstituted quaternary ammonium polymers; quaternized vinylimidazole polymers; dialkylimidazolium; poly(aerylie acid); polystyrenesulfonates; cationically or anionically modified polymers of polysaccharides, poly(meth)acrylamide, poly(meth)acrylate, chitosan, polyalkyleneimines, polyamidoamines, polyepihydrin, polyamines; polyvinyl-heterocycles; N-vinyl lactams; copolymers thereof, and blends thereof.

In certain examples, the second polymer can be an anionic polymer. Suitable anionic polymers can include an anionic moiety, such as a sulfonate, sulfate, borate, carboxylate, phosphonate, phosphate, thioacetate, thiols, thiosulphate, oxalate, nitro, alkoxide, or combinations thereof. Examples of suitable anionic polymers or polymers that can be modified to contain an anionic group can include polyesters, poly(meth)acrylates, polyacrylic acids, polysulfonates, polysaccharides, polycarboxylates, polyphosphonate, polyphosphonite, polysiloxanes, polyurethanes, polythioethers, polycarbonates, polyarylalkylenes, polyalkylenes, polysilanes, polyesteramides, polyacetal, polysulfones, polystyrenes, polyacrylamides, polyvinyl alcohols, derivatives thereof, copolymers thereof, and blends thereof.

In certain examples, the adhesion layer can include polyethyleneimine, polyvinylamines, polyallylamines, polyetheramines, polyvinylamine, poly-N-isopropylallylamine, poly-N-tert-butylallylamine, poly-N-1, 2-dimethylpropylallylamine, poly-N-methylallylamine, poly-N,N-dimethylallylamine, polyallcylammonium, poly(lactic-co-glycolic acid), polydiallyldiethyl ammonium compounds, diallyldimethyl ammonium compounds, polyvinylbenzonyltrimethylammonium chloride, (polymethacryloyloxy)ethyl-trimethylamnionium chloride, 1-ethyl-3-methylimidazolium, [(methacryloyloxy)ethyl]trimethyl ammonium compounds, [(methacrylamido)propyl]trimethyl ammonium compounds. [(acryloyloxy)]ethyl]trimethyl ammonium compounds, (acrylamidomethylpropyl)trimethyl ammonium compounds, [(acrylamide)methyl]butyl trimethyl ammonium compounds, poly-2-vinylpiperidine, poly-4-vinylpiperidine, polyaminostyrene, derivatives thereof, copolymers thereof, and blends thereof. In some embodiments, the second polymer can include a polydialkyldiallylammonium compound such as polydimethyldiallylammonium.

In some embodiments, the first polymer and the second polymer are the same. In some embodiments, the first polymer and the second polymer are different.

The multilayer coating can further include a functional layer. The functional layer can be disposed on the adhesion layer and can form a surface of the multilayer coating.

The functional layer can include any suitable material based on the desired surface properties of the coating. In some embodiments, the functional layer can comprise a superoleophilic material, a superoleophobic material, a superhydrophobic material, a superhydrophilic material, or combinations thereof. In certain embodiments, the functional layer can comprise a superhydrophilic/superoleophilic material, a superhydrophobic/superoleophilic material, a superhydrophobic/superoleophobic material, or a superhydrophilic/superoleophobic material.

The functional layer can be derived from any suitable material, including polymers and small molecules. In some embodiments, the functional layer can include a silane. The silane can be halogenated or non-halogenated. In some embodiments, the silane can comprise an alkyl chain, a partially fluorinated alkyl chain, and/or an alkyl chain that has regions that are perfluorinated, any of which may be straight or branched. In some examples, the silane group can comprise one or more perfluorinated aliphatic moieties.

In some examples, the functional layer can comprise a silane represented by a general Formula below

CH₃(CH₂)ₘSiR¹R²R³ I,

CF₃(CF₂)ₙ(CH₂)ₘSiR¹R²R³ II, or

CHF₂(CF₂)ₙ(CH₂)ₘSiR¹R²R³ III

where n and m are integers (n is 0 or greater, and m is 0 or greater), and R¹, R², and R³ are independently a halogen, alkyl, or alkoxy group.

In some embodiments, the functional layer can comprise one or more silanes represented by Formulas I-III. In some examples, the functional layer can comprise perfluoroalkyltrichlorosilane, perfluoroalkyl(alkyl)dichlorosilane, perfluoroalkyl(alkyl)dialkoxylsilanes, of perfluoroalkyltrialkoxysilanes. Specifically, the functional layer can comprise perfluorododecyltrichlorosilane, perfluorotetradecyltrichlorosilane, perfluorooctyltrichlorosilane, perfluorodecyltrimethoxysilane, perfluorododecyltrimethoxysilane, perfluorotetradecyltrimethoxtsilane, perfluorooctyltrimethoxysilane, perfluorodecyltriethoxysilane, perfluorododecyltrimethoxysilane, perfluorotetradecyltriethoxysilane, perfluorooctyltrimethoxysilane, and perfluorodecylmethyldichlorosilane.

In some embodiments, the functional layer can include a fluorosurfactant. Suitable flourosurfactants can include anionic fluorosurfactants and cationic fluorosurfactants. Examples of suitable fluorosurfactants include those sold under the tradenames FLEXIPEL™, ZONYL®, CAPSTONE®, and MASURF®. Specific examples of suitable fluorosurfactants include FLEXIPEL™ AM-101 partially fluorinated polymer, ZONYL® 9361 anionic fluorosurfactant, CAPSTONE® FS-50 anionic fluorosurfactant, CAPSTONE® FS-63 anionic fluorosurfactant, and MASURF® FP-815CP anionic fluoroacrylate copolymer.

The functional layer can be uniformly distributed across the adhesive layer. Alternatively, the functional layer can be patterned. For example, the functional layer can be present at some points on the adhesive layer and absent at others, such that the material forming the functional layer is present at some points on the surface of the multilayer coating while the material forming the adhesion layer is present at other points on the surface of the multilayer. In other cases, the functional layer can be patterned such that the composition of the functional layer varies at different points on the adhesive layer, such that a first material is present at some points on the surface of the multilayer coating and a second material is present at some points on the surface of the multilayer coating. When the functional layer is patterned, the pattern of the functional layer can be random or ordered.

The total thickness of each layer in the coating can be chosen such that the structure is mechanically robust, but not so thick as to impair permeability. In some embodiments, the fixed layer can have a thickness of from about 50 nm to about 400 nm (e.g., from about 100 nm to about 400 nm, from about 150 nm to about 250 nanometers). In some embodiments, the inorganic layer can have a thickness of from about 50 nanometers to about 800 nanometers (e.g., from about 200 nanometers to about 800 nanometers, from about 250 nm to about 650 nanometers, about 300 nm to about 600 nanometers, or about 250 nm to about 450 nanometers). In some embodiments, the adhesion layer can have a thickness of from about 5 nanometers to about 250 nanometers (e.g., from about 5 nanometers to about 100 nanometers, or from about 5 to about 80 nanometers). In some embodiments, the functional layer can have a thickness of less than about 100 nanometers (e.g., less than about 50 nanometers, less than about 25 nanometers, less than about 10 nanometers, or less than about 5 nanometers). In some embodiments, the functional layer can have a thickness of from about 5 nanometers to about 100 nanometers (e.g., from about 5 to about 80 nanometers).

In some cases, the multilayer coatings disclosed herein can have a thickness of from about 100 nanometers to about 2 microns (e.g., from about 400 nanometers to about 2 microns, from about 500 nanometers to about 2 microns, from about 500 nanometers to about 1.5 micron, from about 100 nanometers to about 800 nanometers, or from about 500 nanometers to about 1 micron). In some cases, the multilayer coatings disclosed herein can have a thickness of less than 1 micron (e.g., less than about 750 nanometers).

Methods of making the coatings described herein are also disclosed. The method can include depositing two or more oppositely charged alternating layers on a surface of the substrate, the two or more oppositely charged alternating layers comprising, at least one fixed layer and at least one inorganic layer. In some embodiments, the method can include depositing a first polymer on the surface of the substrate to form a fixed layer disposed on the substrate. The first polymer can be in the form of a solution. The method can include depositing a plurality of particles having a charge opposite that of the first polymer on the fixed layer to form an inorganic layer disposed on the fixed layer. The particles can be in the form of a dispersion. The method can also include depositing a second polymer having a charge opposite that of the plurality of particles on the inorganic layer to form an adhesion layer disposed on the inorganic layer. The second polymer can be in the form of a solution. The method can further include depositing a functional material on the adhesion layer to form a functional layer disposed on the adhesion layer.

Depositing the fixed layer, inorganic layer, adhesion layer, or functional layer can include any suitable casting technique. Examples of suitable casting techniques can include spray coating, dip coating, spin coating, flow coating, layer-by-layer coating, knife casting, film casting, vacuum-assisted dip-deposition, plasma deposition, or chemical vapor deposition. Dip coating include a process in which a polymer solution is contacted with a surface. Excess solution is permitted to drain from the surface, and the solvent of the polymer solution is evaporated at ambient or elevated temperatures. Knife casting include a process in which a knife is used to draw a polymer solution across a flat substrate to form a thin film of a solution/dispersion of uniform thickness after which the solvent of the solution/dispersion is evaporated, at ambient temperatures or temperatures up to about 100° C. or higher, to yield a fabricated membrane. The coatings disclosed herein can be shaped in the form of hollow fibers, tubes, films, sheets, etc. Pretreatment of each layer may be necessary to remove water or other adsorbed species using methods appropriate to the existing layer and the adsorbate. Examples of absorbed species are, for example, water, alcohols, and porogens.

In one example method of preparing a coating disclosed herein, the first polymer can be prepared by first forming a solution of a first polymer in a suitable solvent One example of a suitable solvent is water. In some embodiments, the amount of solvent employed can be from about 50% to about 99%, by weight of the solution. The solution can then be used in forming a fixed layer of the coating. The solution can be cast onto a substrate using any suitable technique described herein, and the solvent can be evaporated such that a fixed layer is formed on the substrate.

The particles, for example, silicon dioxide particles can be dispersed in a suitable solvent, for example acetone via ultrasonication. In some embodiments, the amount of solvent employed can be in the range of from about 50% to about 99%, by weight of the solution. During sonication, the solvent can be changed intermittently to prevent a temperature rise. The particle dispersion can then be deposited onto the fixed layer using any suitable technique described herein. In some embodiments, the particle dispersion can be deposited by spray coating or vacuum assisted dip-deposition. Vacuum-assisted dip-depositing can include tangentially dipping the top surface of a fixed layer into the dispersion and then taken out. The vacuum can be used to assist the inorganic layer formation as well as keep the fixed layer flat during the deposition process. After the deposition, the inorganic layer can be dried overnight at room temperature prior to further characterization. The inorganic layer can be characterized by Scanning Electron Microscopy (SEM) and/or Dynamic Light Scattering.

The second polymer can be prepared as a solution, as described for the first polymer. The solution can then be used in forming an adhesive layer in the coating. The adhesive layer can be formed using any suitable techniques as described herein. In some examples, the adhesive layer can be formed by spray coating.

The functional layer can be prepared by first forming a solution of a functional material in a suitable solvent. One example of a suitable solvent is ethanol. In some embodiments, the amount of solvent employed can be in the range of from about 50% to about 99%, by weight of the solution. The solution can then be used in forming a functional layer in the coating. The functional layer can be formed using any suitable technique described herein. In some examples, the adhesive layer can be formed by spray coating or chemical vapor deposition. If desired, the functional layer can be surface modified by, for example, chemical grafting, blending, or coating to improve the performance of the functional layer. For example, hydrophobic components may be added to the functional layer to alter the properties of the functional layer in a manner that facilitates greater fluid selectivity.

The coating can exhibit a water contact angle of at least about 150° and a hexadecane contact angle of at least about 150°. In some embodiments, the coating can exhibit a water contact angle of less than about 10° and a hexadecane contact angle of at least about 150°. In some embodiments, the coating can exhibit a water contact angle of less than about 10° and a hexadecane contact angle of less than about 10°. The tilt angle of the coatings described herein can be about 10° or less. For example, the tilt angle of the coating can be about 9° or less, about 8° or less, about 7° or less, about 6° or less, about 5° or less, about 4° or less, about 3° or less, or about 2° or less. In some embodiments, the coating can exhibit a tilt angle of from about 2° to about 10°. In some examples, the superoleophobic coating can exhibit a hexadecane contact angles greater than about 150° and a tilt angle of less than about 5°, whilst the superhydrophobic coating can exhibit a water contact angle of greater than about 160° with a tilt angle of less than about 2°.

The coatings described herein can exhibit good scrub resistance (also referred to herein as “wear resistance”). In some embodiments, the coating can exhibit scrub resistance of at least about 50 cycles at 10 mN (e.g., at least about 100 cycles, at least about 150 cycles, at least about 200 cycles, at least about 300 cycles, at least about 400 cycles, at least about 500 cycles, at least about 600 cycles, at least about 700 cycles, at least about 800 cycles, at least about 900 cycles, at least about 1,000 cycles, at least about 1,100 cycles, at least about 1,200 cycles, at least about 1,300 cycles, at least about 1,400 cycles, or at least about 1,500 cycles) as measured in accordance with the methods described herein. In some embodiments, the coating can exhibit scrub resistance of about 2,000 cycles or less (e.g., about 1,500 cycles or less, about 1,200 cycles or less, about 1,000 cycles or less, or about 500 cycles or less) as measured in accordance with the methods described herein.

The coating composition can exhibit a scrub resistance ranging from any of the minimum values described above to any of the maximum values described above. For example, the coating compositions can exhibit a scrub resistance of from about 50 cycles to about 2,000 cycles. The scrub resistance of the coating can be measured using any suitable method described herein. Briefly, the surface can be worn using a borosilicate ball with radius 15 μm mounted on a rectangular cantilever with a nominal spring constant. To analyze the change in morphology of the surface before and after the wear experiment, height scans of 100×100 μm² in area can be obtained using a Si, n-type (Si₃N₄) tip with an Al coating operating in tapping mode. Root mean square roughness (RMS) values before and after wear experiments can be obtained.

The coatings disclosed herein can be used for separating a fluid mixture comprising a first liquid and a second liquid. For example, the coatings can be used to separate a polar liquid from a non-polar liquid. “Polar” as used herein, refers to a fluid having molecules whose electric charges are not equally distributed and are therefore electronically charged.

Polar fluids are immiscible or hardly miscible with non-polar or hydrophobic fluids. “Non-polar” as used herein refers to a hydrophobic fluid. Non-polar fluids are immiscible, or hardly miscible with polar fluids such as for example water. The dielectric constant of a non-polar fluid is usually lower than that of water. Examples of a hydrophobic liquids include aliphatic hydrocarbons such as octanol, dodecane, or hexadecane. In some examples, the coatings can be used to separate a mixture of water and a non-polar liquid, such as an aliphatic hydrocarbon.

Methods of using the coatings can include contacting the coating, on the side comprising the functional polymer, with the fluid mixture under conditions effective to afford permeation of the polar liquid or the non-polar liquid. In some embodiments, the method can include withdrawing from the reverse side of the coating a permeate containing at least one liquid, wherein the liquid is selectively removed from the fluid mixture. The permeate can comprise at least one liquid in an increased concentration relative to the feed stream. The term “permeate” refers to a portion of the feed stream which is withdrawn at the reverse or second side of the coating, exclusive of other fluids such as a sweep gas or liquid which may be present at the second side of the coating.

In some embodiments, the coating can be selective to the polar liquid versus the non-polar liquid. In some embodiments, the coating can be selective to the non-polar liquid versus the polar liquid. In some embodiments, the coating can be impermeable to both the polar liquid and the non-polar liquid. The coating can be used to separate fluids at any suitable temperature, including temperatures of about 100° C. or greater. For example, the coating can be used at temperatures of from about 100° C. to about 180° C. In some embodiments, the coating can be used at temperatures less than about 100° C.

In certain embodiments, the coating can exhibit superhydrophilic/superoleophilic properties, superhydrophobic/superoleophilic properties, superhydrophobic/superoleophobic properties, or superhydrophilic/superoleophobic properties. As such, the coatings described herein can impart various desirable properties, such as, for example, self-cleaning, anti-fouling, anti-smudge, and anti-icing properties to an article. In some embodiments, the surface of the article can comprise glass, fiberglass, plastic, ceramic, metal, fused silica, woven fabric, or non-woven fabric. In some embodiments, the coating can be used for microbial resistance, applied to surfaces that are prone to the moisture-induced deterioration, where moisture resistance is desired (e.g., metallic surface or other surfaces including wooden or ceramic surface), anti-fouling of surfaces, filters, membranes, actuators, in packaging materials, in anti-fingerprint surfaces, in self-cleaning and dirt-repellent surfaces, as coatings for miniaturized sensors or other devices, in biochips, in floating devices such as superfast swimsuits, in oil tankers to prevent oil leakage, as thermal insulator in clothing, cooking ware, traffic, airplanes, boats and buildings, as weight support, as a material with low permittivity, as a selective membrane, as air filter, and in liquid extraction from mixtures.

Specific examples of articles on which the coatings described herein can be applied can include, windows; windshields on automobiles aircraft, and watercraft; freezer doors; condenser pipes; ship hulls; underwater vehicles; underwater projectiles; airplanes and wind turbine blades; indoor and outdoor mirrors; lenses, eyeglasses or other optical instruments; protective sports goggles; masks; helmet shields; glass slides of frozen food display containers; glass covers; buildings walls; building roofs; exterior tiles on buildings; building stone; painted steel plates; aluminum panels; window sashes; screen doors; gate doors; sun parlors; handrails; greenhouses; traffic signs; transparent soundproof walls; signboards; billboards; guardrails; road reflectors; decorative panels; solar cells; painted surfaces on automobiles watercraft, aircraft, and the like; painted surfaces on lamps; fixtures, and other articles; air handling systems and purifiers; kitchen and bathroom interior furnishings and appliances; ceramic tiles; air filtration units; store showcases; computer displays; air conditioner heat exchangers; high-voltage cables; exterior and interior members of buildings; window panes; dinnerware; walls in living spaces, bathrooms, kitchens, hospital rooms, factory spaces, office spaces, and the like; sanitary ware, such as basins, bathtubs, closet bowls, urinals, sinks, and the like; and electronic equipment, such as computer displays.

### EMBODIMENTS

Embodiment 1. A multilayer coating comprising a plurality of layers having alternating charge, the plurality of layers comprising:
   a. two or more base layers, the two or more base layers comprising,
      i. a fixed layer comprising a first polymer having a charge,
      ii. an inorganic layer comprising a plurality of particles having a charge;
   b. an adhesion layer disposed on the two or more base layers, the adhesion layer comprising a second polymer having a charge; and
   c. a functional layer disposed on the adhesion layer, wherein the functional layer forms a surface of the multilayer coating.
Embodiment 2. The multilayer coating of Embodiment 1, wherein the adhesion layer is disposed on the inorganic layer.
Embodiment 3. The multilayer coating of Embodiment 1 or 2, wherein the first polymer has a charge opposite that of the plurality of particles, and wherein the second polymer has a charge opposite that of the plurality of particles.
Embodiment 4. The multilayer coating of any of Embodiments 1-3, wherein the multilayer coating comprises
   a. a fixed layer comprising a first polymer haying a charge;
   b. an inorganic layer disposed on the fixed layer, the inorganic layer comprising a plurality of particles haying a charge opposite that of the first polymer;
   c. an adhesion layer disposed on the inorganic layer, the adhesion layer comprising a second polymer haying a charge opposite that of the plurality of particles; and
   d. a functional layer disposed on the adhesion layer, wherein the functional layer forms a surface of the multilayer coating.
Embodiment 5. The multilayer coating of any of Embodiments 1-4, wherein the charge density of the first polymer is at least about 0.5 meq/g.
Embodiment 6. The multilayer coating of any of Embodiments 1-5, wherein the charge density of the first polymer is from about 1.0 to about 20 meq/g.
Embodiment 7. The multilayer coating of any of Embodiments 1-6, wherein the charge density of the first polymer is from about 1.5 to about 10 meq/g.
Embodiment 8. The multilayer coating of any of Embodiments 1-7, wherein the second polymer has a charge density of at least about 0.5 meq/g.
Embodiment 9. The multilayer coating of any of Embodiments 1-8, wherein the charge density of the second polymer is from about 1.0 to about 20 meq/g.
Embodiment 10. The multilayer coating of any of Embodiments 1-9, wherein the charge density of the second polymer is from about 1.5 to about 10 meq/g.
Embodiment 11. The multilayer coating of any of Embodiments 1-10, wherein the first polymer and the second polymer, independently, have a weight average molecular weight of from about 50,000 to about 1,000,000 Da.
Embodiment 12. The multilayer coating of any of Embodiments 1-11, wherein the first polymer and the second polymer, independently, have a weight average molecular weight of from about 100,000 to about 200,000 Da.
Embodiment 13. The multilayer coating of any of Embodiments 1-12, wherein the first polymer is a cationic polymer and the second polymer is a cationic polymer.
Embodiment 14. The multilayer coating of any of Embodiments 1-13, wherein the fixed layer has a thickness of from about 50 nm to about 400 nm.
Embodiment 15. The multilayer coating of any of Embodiments 1-14, wherein the fixed layer has a thickness of from about 150 nm to about 250 nm.
Embodiment 16. The multilayer coating of any of Embodiments 1-15, wherein the fixed layer is disposed on a substrate.
Embodiment 17. The multilayer coating of any of Embodiments 1-16, wherein the adhesion layer has a thickness of from about 5 nm to 250 nm.
Embodiment 18. The multilayer coating of any of Embodiments 1-17, wherein the plurality of particles comprise a plurality of anionic particles.
Embodiment 19. The multilayer coating of any of Embodiments 1-18, wherein the plurality of particles comprises a plurality of nanotubes.
Embodiment 20. The multilayer coating of any of Embodiments 1-19, wherein the plurality of particles comprises a plurality of nanoparticles.
Embodiment 21. The multilayer coating of Embodiment 20, wherein the plurality of nanoparticles have an average particle size of from about 1 nm to about 200 nm.
Embodiment 22. The multilayer coating of Embodiment 20 or 21, wherein the plurality of nanoparticles have an average particle size of from about 1 nm to about 50 nm.
Embodiment 23. The multilayer coating of any of Embodiments 20-22, wherein the plurality of nanoparticles are selected from the group consisting of alkaline earth metal oxide nanoparticles, transition metal oxide nanoparticles, lanthanide metal oxide nanoparticles, group WA oxide nanoparticles, transition metal nanoparticles, transition-metal catalyst nanoparticles, metal alloy nanoparticles, silicate nanoparticles, alumino-silicate nanoparticles, clays, and combinations thereof.
Embodiment 24. The multilayer coating of any of Embodiments 1-23, wherein the plurality of particles comprise silicon dioxide.
Embodiment 25. The multilayer coating of any of Embodiments 1-24, wherein the inorganic layer has a thickness of from about 50 nm to about 800 nm.
Embodiment 26. The multilayer coating of any of Embodiments 1-25, wherein the inorganic layer has a thickness of from about 250 nm to about 450 nm.
Embodiment 27. The multilayer coating of any of Embodiments 1-26, wherein the functional layer comprises a superoleophilic material, a superoleophobic material, a superhydrophobic material, a superhydrophilic material, or combinations thereof.
Embodiment 28. The multilayer coating of any of Embodiments 1-27, wherein the functional layer is patterned.
Embodiment 29. The multilayer coating of any of Embodiments 1-28, wherein the functional layer comprises a charged material, and wherein the charged material has a charge opposite that of the second polymer.
Embodiment 30. The multilayer coating of any of Embodiments 1-29, wherein the functional layer is covalently attached to the adhesion layer.
Embodiment 31. The multilayer coating of any of Embodiments 1-30, wherein the functional layer comprises a halogenated silane.
Embodiment 32. The multilayer coating of any of Embodiments 1-31, wherein the functional layer comprises a fluorosurfactant.
Embodiment 33. The multilayer coating of any of Embodiments 1-32, wherein the functional layer has a thickness of about 100 nm or less.
Embodiment 34. The multilayer coating of any of Embodiments 1-33, wherein the functional layer has a thickness of from about 5 nm to about 100 nm.
Embodiment 35. The multilayer coating of any of Embodiments 1-34, wherein the multilayer coating has a thickness of from about 100 nm to about 2 microns.
Embodiment 36. The multilayer coating of any of Embodiments 1-35, wherein the multilayer coating has a thickness of from about 100 nm to about 800 nm.
Embodiment 37. The multilayer coating of any of Embodiments 1-36, wherein the fixed layer, the inorganic layer, the adhesion layer, and the functional layer are bonded together by electrostatic force, dipole-dipole interactions, hydrogen bonding, or a combination thereof.
Embodiment 38. The multilayer coating of any of Embodiments 1-37, wherein the surface of the multilayer coating exhibits a water contact angle of at least about 150° and a hexadecane contact angle of at least about 150°.
Embodiment 39. The multilayer coating of any of Embodiments 1-38, wherein the surface of the multilayer coating exhibits a water contact angle of less than about 10° and a hexadecane contact angle of at least about 150°.
Embodiment 40. The multilayer coating of any of Embodiments 1-39, wherein the surface of the multilayer coating exhibits a water contact angle of less than about 10° and a hexadecane contact angle of less than about 10°.
Embodiment 41. The multilayer coating of any of Embodiments 1-40, wherein the surface of the multilayer coating exhibits a tilt angle of about 10° or less.
Embodiment 42. The multilayer coating of any of Embodiments 1-41, wherein the surface of the multilayer coating exhibits a tilt angle of from about 2° to about 10°.
Embodiment 43. The multilayer coating of any of Embodiments 1-42, wherein when the first polymer and the second polymer consist of polydiallyldimethylammonium and the plurality of particles consist of silicon dioxide nanoparticles, the functional layer is not a fluorosurfactant.
Embodiment 44. The multilayer coating of any of Embodiments 1-42, wherein when the first polymer and the second polymer consist of polydiallyldimethylammonium and the plurality of particles consist of silicon dioxide nanoparticles, the functional layer is not negatively charged.
Embodiment 45. A coated article comprising the multilayer coating of any one of Embodiments 1-44.
Embodiment 46. The article of Embodiment 45, wherein the article comprises a mesh comprising the multilayer coating of any one of Embodiments 1-44.
Embodiment 47. A method of forming a multilayer coating on a substrate, comprising:
   a. depositing two or more base layers having alternating charge on a surface of the substrate, the two or more base layers comprising,
      i. a fixed layer comprising a first polymer having a charge,
      ii. an inorganic layer comprising a plurality of particles having a charge;
   b. depositing a second polymer having a charge on the two or more base layers to form an adhesion layer; and
   c. depositing a functional material on the adhesion layer to form a functional layer disposed on the adhesion layer.
Embodiment 48. The method of Embodiment 47, comprising:
   a. depositing a first polymer having a charge on a surface of the substrate to form a fixed layer disposed on the substrate;
   b. depositing a plurality of particles having a charge opposite that of the first polymer on the fixed layer to form an inorganic layer disposed on the fixed layer;
   c. depositing a second polymer having a charge opposite that of the plurality of particles on the inorganic layer to form an adhesion layer disposed on the inorganic layer; and
   d. depositing a functional material on the adhesion layer to form a functional layer disposed on the adhesion layer.
Embodiment 49. The method of Embodiment 47 or 48, wherein the depositing comprises film casting, spin coating, dip coating, spray coating, flow coating, layer-by-layer coating, vapor deposition, knife casting, film casting, vacuum-assisted dip-deposition, plasma deposition, or a combination thereof.
Embodiment 50. The method of any of Embodiments 47-49, wherein the substrate is wholly or partially coated with the multilayer coating.
Embodiment 51. The method of any of Embodiments 47-50, wherein the method comprises treating the substrate to improve adhesion of the multilayer coating.
Embodiment 52. A method of separating a liquid mixture comprising a polar liquid and a non-polar liquid, the method comprising contacting the article of Embodiment 45 or 46 with the liquid mixture under conditions effective to afford permeation of the polar liquid or the non-polar liquid through the article.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the scope of the disclosure. Unless indicated otherwise, parts are parts by weight, temperature is in ° C. or is at ambient temperature, and pressure is at or near atmospheric.

### Example 1

### Bioinspired, Roughness-Induced, Water and Oil Superphilic and Superphobic Coatings Prepared by Layer-by-Layer Technique

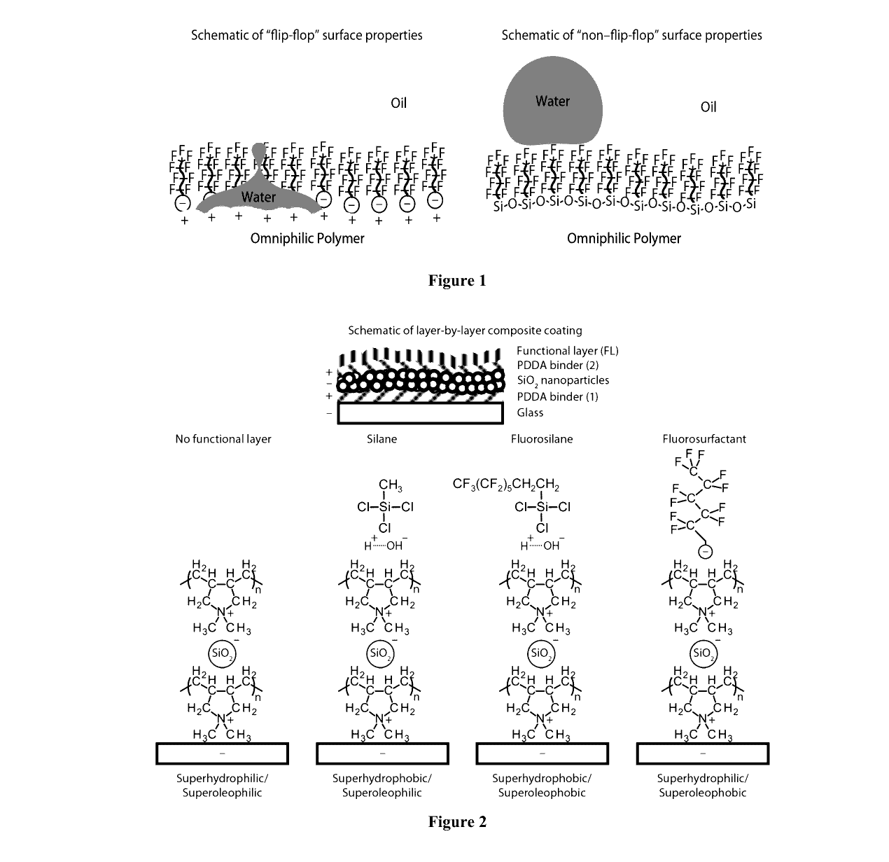

Surfaces that repel oils typically also repel water. This is primarily due to water having a higher surface tension than oils. However, it is possible to create a coating that repels oils but attracts water. This can be achieved through the use of a fluorosurfactant. A fluorosurfactant contains a high surface tension head group and a low surface tension tail group. When deposited onto a surface, the fluorinated tails segregate at the air interface resulting in a low surface tension barrier that repels oils. However, when droplets of water are placed on such a surface, they are able to penetrate down through the tail groups to reach the high surface tension polar head groups below, and thus the coating appears hydrophilic. FIG. 1 schematically compares this so called “flip-flop” of surface properties to that of a typical, “non-flip-flop”, case where penetration does not occur.

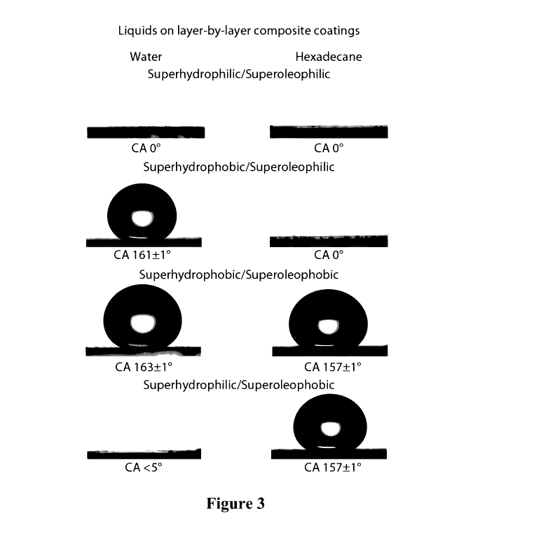

The coatings described in this example comprises various layers as shown in FIG. 2, deposited separately, each of which aids the creation of a mechanically durable, functional coating. Polydiallyldimethylammonium (PDDA) was chosen as the polymer base layer as it has a high cationic charge density and has been shown to bind strongly to glass substrates (Du et al., 2010; Lee and Ahn, 2013) and SiO₂ nanoparticles. The selected molecular weight range (100,000-200,000) can balance mechanical properties and ease of deposition (viscosity). Untreated, hydrophilic SiO₂ nanoparticles were used to enhance the roughness of the coating. The negatively charged surface silanol groups have good adhesion to the positively charged polymer layers. Additionally, SiO₂ nanoparticles are known to have high hardness (Ebert and Bhushan, 2012) and wear resistance (Lvov et al., 1997). Particles of 7 nm in diameter can create a transparent coating. The material selected for the final, functional layer varied depending upon the desired surface properties. For the superhydrophilic/superoleophilic coating, no additional layer was deposited. For the superhydrophobic/superoleophilic and superhydrophobic/superoleophobic coatings, two different silanes (non-fluorinated and fluorinated silanes respectively) were selected to provide the desired repellency and because of their ability to form self-assembled layers via vapor phase deposition. Silanes have been shown to condense on hydrophilic polymer layers in the past due to the presence of absorbed water (Xie et al., 2010). Finally, for the superhydrophilic/superoleophobic coating (“flip-flop” coating, FIG. 1), a fluorosurfactant was selected for its oil repellency (low surface tension tail) and its ability to complex to a positively charged polyelectrolyte (high surface tension head group).

Methods

Samples: Glass slides (Fisher Scientific) cut to dimensions of 25 by 10 mm were used as substrates. Polydiallyldimethylammonium chloride (PDDA, MW 100,000-200,000, Sigma Aldrich) was dissolved in distilled water (DS Waters of America Inc.) at various concentrations. Silica nanoparticles (NP, 7 nm diameter, Aerosil 380, Evonik Industries) were dispersed in acetone (Fisher Scientific Inc.) using an ultrasonic homogenizer (Branson Sonifier 450A, 20 kHz frequency at 35% amplitude) at various concentrations. The fluorosurfactant solution (FL, Capstone FS-50, DuPont) was diluted with ethanol (Decon Labs Inc) so that the overall fluorosurfactant concentration was 45 mg mL⁻¹. Coatings were deposited via spray gun (Paasche) operated with compressed air at 210 kPa. The gun was held 10 cm from the glass slide at all times. First, PDDA solution (52 mg mL⁻¹, 2 mL) was spray coated and any excess was removed from the surface via bursts of compressed air from the spray gun. Second, the SiO₂ NP solution (various concentrations, 3 mL) was spray coated. Third, a second PDDA layer was deposited (8 mg mL⁻¹, 1 mL). After this, the samples were transferred to an oven operating at 140° C. for 1 h. Finally, the functional layer (FL) was deposited either via spray coating or chemical vapor deposition under atmospheric conditions. For spray coating, the fluorosurfactant solution (1 mL) was spray coated and the samples were allowed to dry in air. For chemical vapor deposition, one drop of either methyltrichlorosilane (methylsilane, Sigma Aldrich) for superhydrophobic/superoleophilic coatings or trichloro(1H,1H,2H,2H-perfluorooctyl) silane (fluorosilane, Sigma Aldrich) for superhydrophobic/superoleophobic coatings was deposited next to the samples which were covered and left for 6 h.

Contact angle and tilt angle: For contact angle data, 5-μL, droplets of water and n-hexadecane (99%, Alfa Aesar) were deposited onto samples using a standard automated goniometer (Model 290, Ramé-Hart Inc.) and the resulting image of the liquid-air interface analyzed with DROPimage software. Tilt angles were measured by inclining the surface until the 5 μL droplet rolled off Contact angle hysteresis was measured by tilting the substrate until the droplet was observed to move and the advancing and receding angles were recorded. These numbers were found to be comparable to the tilt angles and are not reported. All angles were averaged over at least five measurements on different areas of a sample.

Coating thickness: Coating thickness of each individual layer and the composite coating was measured with a step technique. One half of the substrate was covered with a glass slide using double-sided sticky tape before coating and then removed after the coating procedure resulting in a step. An area including the step was imaged using a D3000 Atomic Force Microscopy (AFM) with a Nanoscope IV controller (Bruker Instruments) to obtain the coating thickness. A Si, n-type (Si₃N₄) tip with an Al coating (resonant frequency f=66 kHz, spring constant k=3 N m⁻¹, AppNano) operating in tapping mode was used.

Wear experiments: The mechanical durability of the surfaces was examined through wear experiments using an AFM and a ball-on-flat tribometer (Bhushan, 2011). An established AFM micro-wear procedure was performed with a commercial AFM (D3000, Nanoscope IV controller, Bruker Instruments). Surfaces were worn using a borosilicate ball with radius 15 μm mounted on a rectangular cantilever with nominal spring constant of 7.4 N m⁻¹ (resonant frequency f=150 kHz, All-In-One). Areas of 50×50 μm² were worn for 1 cycle at a load of 10 μN so as to be later imaged within the scanning limits of the AFM. To analyze the change in morphology of the surface before and after the wear experiment, height scans of 100×100 μm² in area were obtained using a Si, n-type (Si₃N₄) tip with an Al coating (resonant frequency f=66 kHz, k=3 N m⁻¹, AppNano) operating in tapping mode. Root mean square roughness (RMS) values before and after wear experiments were obtained.

Macrowear experiments were performed with an established procedure of using a ball-on-flat tribometer (Bhushan, 2013). A sapphire ball of 3 mm diameter was fixed in a stationary holder. A load of 10 mN was applied normal to the surface, and the tribometer was put into reciprocating motion. Stroke length was 6 mm with an average linear speed of 1 mm s⁻¹. Surfaces were imaged before and after the tribometer wear experiment using an optical microscope with a CCD camera (Nikon Optihot-2) to examine any changes (Ebert and Bhushan, 2012).

Contact pressures for both AFM and tribometer wear experiments were calculated based on Hertz analysis (Bhushan, 2013). The elastic modulus of PDDA, 0.16 GPa (Podsiadlo, 2008), was used to estimate the elastic modulus of the composite coating, and a Poisson's ratio of 0.5 was used (estimated). The elastic modulus of final coating is expected to be higher, so an underestimated pressure will be obtained with the selected modulus. The elastic modulus of 70 GPa and Poisson's ratio of 0.2 were used for the borosilicate ball used in the microscale wear experiments (Callister, 2013). The elastic modulus of 390 GPa and Poisson's ratio of 0.23 were used for sapphire ball used in the macroscale wear experiments (Bhushan and Gupta, 1991). The mean contact pressures were calculated as 4.87 MPa and 2.26 MPa for the AFM (micro) and ball-on-flat tribometer (macro) experiments respectively. Microscale wear experiments were performed for 1 cycle while macroscale wear experiments were performed for 100 cycles. Therefore, the macroscale wear experiments can cause a relatively high degree of damage to the coating even though the mean contact pressures are comparable to the microscale technique.

Self-cleaning experiment: The self-cleaning characteristics of the surfaces were examined using an experimental setup previously reported (Bhushan, 2012). Coatings were contaminated with silicon carbide (SiC, Sigma Aldrich) in a glass chamber (0.3 m diameter and 0.6 m high) by blowing 1 g of SiC powder onto a sample for 10 s at 300 kPa and allowing it to settle for 30 min. The contaminated sample was then secured on a stage (45° tilt) and water droplets (total volume 5 mL) were dropped onto the surface from a specified height. Once dried, images were taken using an optical microscope with a CCD camera (Nikon, Optihot-2). The removal of particles by the water droplets was compared before and after tests. The ability for the water stream to remove particles was quantified using image analysis software (SPIP 5.1.11, Image Metrology A/S, Horshølm, Denmark).

Anti-smudge experiment: The anti-smudge characteristics of the surfaces were examined using an experimental setup previously reported (Bhushan and Muthiah, 2013). Coatings were contaminated as reported above. The contaminated sample was then secured on a stage and a hexadecane-impregnated microfiber wiping cloth was glued to a horizontal glass rod (radius 0.5 mm) fixed on a cantilever above the sample. As the cloth was brought in contact with the sample, the microfiber cloth was set to rub the contaminated sample under a load of 5 g for 1.5 cm at a speed of about 0.2 mm s⁻¹. Images were taken using an optical microscope with a CCD camera (Nikon, Optihot-2). The removal and transfer of particles by the cloth was compared before and after tests.

Anti-icing experiment: The anti-icing characteristics of the surfaces were examined by placing the coated samples in a freezer set at −18° C. for 2 h. The samples were tilted 10° and droplets of supercooled water (−18° C.) were then dropped onto the samples from a height of 5 cm.

Anti-fogging experiment: The anti-fog characteristics of the surfaces were examined by placing the coated samples over boiling water for 5 s. The steam condensed on the coatings and was then photographed to determine the resulting transparency.

Oil-water separation experiment: The superhydrophobic/superoleophilic and superhydrophilic/superoleophobic coatings were found to be suitable for oil-water separation. The stainless steel meshes (#400) were first cleaned with acetone and 2-propanol (Fisher Scientific) until they were found to be hydrophilic, then the coatings were deposited onto the meshes via spray coating. The coated meshes were then placed on top of beakers. Agitated mixtures of hexadecane and water were then poured onto the coated meshes. In separate experiments, the meshes were inclined at an angle and the oil-water mixtures were poured over them. To improve contrast, Oil Red O and Blue 1 were used as oil and water dispersible dyes respectively. The use of dyes was not found to have any effect on the performance of the coating.

Transparency measurements: A line-of-sight light apparatus was assembled using a diffractive spectrometer (Acton, Princeton Instruments), an intensified CCD camera and an incandescent light bulb as a point source, which emitted a black-body type spectrum across the 400-700 nm bandwidth of interest. The sample slides were placed within 1-2 mm of the incandescent light source. A pair of 50-mm diameter, 100-mm focal length plano-convex lenses was used to collect emission from the light source and focus it onto the entrance slits of the spectrometer. For a single camera exposure, the spectrometer bandwidth was approximately 80 nm, so the grating was stepped at ˜60 nm intervals to sample the entire bandwidth with an overlap of about 40 nm between each grating position. A single camera exposure was acquired at each grating position. The spectra were then background subtracted and divided by the spectrum acquired from an uncoated glass slide and the data plotted as a function of wavelength (400-700 nm).

Results and Discussion

Each of the coatings comprise separate layers (total thickness ca. 630 nm) each deposited individually as shown in FIG. 2. The first layer comprises PDDA (thickness ca. 200 nm) and can act as an anchor layer to the glass substrate. The second layer contains SiO₂nanoparticles (NP, thickness ca. 350 nm) and can act as the roughness layer, enhancing the overall liquid-solid interactions. Third is a second polymer layer (PDDA (2), thickness ca. 50 nm), which can help to bind the nanoparticle layer, improving adhesion and mechanical durability. A final, functional layer (FL) is then deposited to provide the desired surface functionality. For the superhydrophilic/superoleophilic coating, there is no separate functional layer used. For superhydrophobic/superoleophilic and superhydrophobic/superoleophobic coatings, the final layer is a silane layer (thickness ca. 25 nm), which condenses onto the hydrophilic PDDA (2) layer and provides either water-(methylsilane) or water- and oil-repellency (fluorosilane). For the superhydrophilic/superoleophobic coating, the final layer is a fluorosurfactant layer (thickness ca. 30 nm), which complexes with the positively charged PDDA (2) layer and provides the oil-repellency. Deposition of a separate functional layer allow the correct functionality at the air interface without compromising the durability of the bulk coating.

Wettability of coated surfaces: Water and hexadecane droplet images and contact angles for all four coatings are shown in FIG. 3. The superhydrophilic/superoleophilic coating was instantly wet by both water and oil. The superhydrophobic/superoleophilic coating was wet by oil whilst repelling water. The superhydrophobic/superoleophobic coating repelled both liquids. Finally, the superhydrophilic/superoleophobic coating repelled oil but was wet by water. Table 1 provides a summary of all contact angle data.

TABLE 1
Comparison of contact and tilt angles for water and hexadecane
droplets deposited on the four layer-by-layer composite coatings.

| | Water | | Hexadecane | |
|---|---|---|---|---|
| | Contact | | Contact | |
| Coating | angle (°) | Tilt angle (°) | angle (°) | Tilt angle (°) |
| Superhydrophilic/ | ~0 | N/A | ~0 | N/A |
| Superoleophilic | | | | |
| Superhydrophobic/ | 161 ± 1 | 2 ± 1 | ~0 | N/A |
| Superoleophilic | | | | |
| Superhydrophobic/ | 163 ± 1 | 2 ± 1 | 157 ± 1 | 4 ± 1 |
| Superoleophobic | | | | |
| Superhydrophilic/ | <5 | N/A | 157 ± 1 | 4 ± 1 |
| Superoleophobic | | | | |

For both superoleophobic coatings, hexadecane contact angles were found to be above 150° with tilt angles <5°, whilst for both superhydrophobic coatings, water contact angles were above 160° with tilt angles <2°. This suggests the formation of a composite air/solid interface and that droplets were in the Cassie-Baxter regime. Oil repellency of both superoleophobic coatings has been further tested in previous work (Brown and Bhushan, 2015a; 2015b). The coatings were found to remain superoleophobic for tetradecane, dodecane, decane, and octane; with only slight increases in tilt angles for the lower chain length oils, due to their lower surface tensions.

The oil repellency of the superhydrophilic/superoleophobic coating, in addition to wetting by water, can be due to the fluorosurfactant containing a low surface tension fluorinated tail and a high surface tension head group complexed with a hydrophilic polyelectrolyte, shown in FIG. 2. During spray coating, the polar head group forms an electrostatic complex with the polyelectrolyte layer below and the fluorinated tails orient themselves at the air interface. Large, bulky oil molecules can be trapped at this fluorinated interface while smaller water molecules can more easily penetrate down through the thin layer (ca. 30 nm) to the hydrophilic region where the surfactant head group complexes with the polyelectrolyte layer (Li et al., 2012; Brown et al., 2014). The result is a “flip-flop” of surface properties and a coating that repels oils but is wet by water, FIG. 1. Water droplets (5 μL) were found to immediately (less than 2 s) wet the surface in contrast to previous work where water penetration can take 5-30 min (Sawada et al., 1996; Sawada et al., 2005; Yang et al., 2012; Saito et al., 2015) and similar behavior was found for both larger and smaller droplets. This may be due to the fluorosurfactant only being present as a single layer at the air interface allowing water to wick down to hydrophilic polyelectrolyte layer beneath. This instant affinity for water allows for an advantage over other techniques in various applications such as anti-fogging and oil-water separation where the water spreads out as quickly as possible.

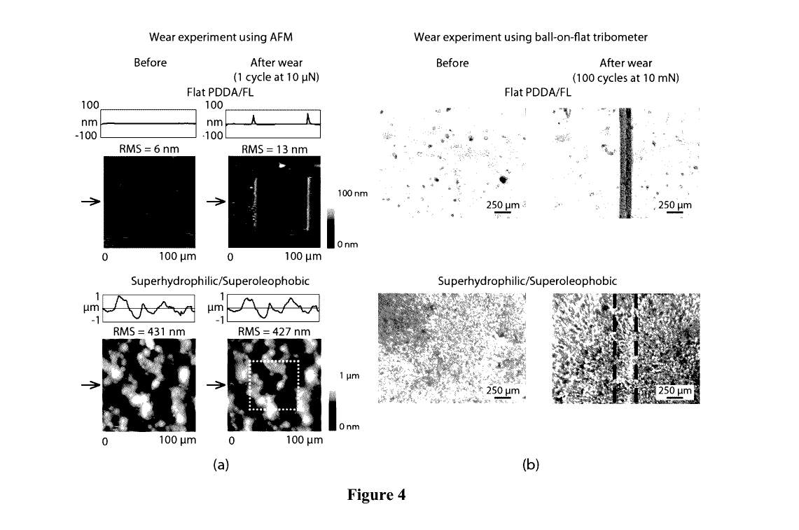

Wear resistance of coated surface: The mechanical durability of the coatings was investigated through the use of AFM and tribometer wear experiments and the resulting images are shown in FIG. 4. AFM images show a 100×100 μm² scan area with the wear location (50×50 μm²) in the center of each image. The optical images show a portion of the wear track from the tribometer experiments. For the soft PDDA/FL coating (ca. 225 nm thick), there is significant wear with both AFM and tribometer experiments causing observable damage to the surface. In contrast, the layer-by-layer composite coating survived the AFM wear experiment with no observable defects. For the tribometer experiment, there is some noticeable burnishing to the coating, however it is minimal when compared to the PDDA/FL coating. Higher magnification images show that the layer-by-layer composite coating morphology is similar before and after the wear test and there is no removal of the coating from the substrate. This is in contrast to the PDDA/FL coating, which was completely destroyed by the wear test to reveal the substrate underneath. Similar results were found for the other three coatings in this example. The hard SiO₂ nanoparticle layer (underneath ca. 75 nm thick PDDA/FL layers) may help improve the durability of the coating, while the oppositely charged PDDA binder layers can help anchor the particles to the glass substrate via an electrostatic bond.

Superhydrophilic/superoleophobic coated samples kept in storage for ca. 9 months were found to retain their surface properties.

To further demonstrate the benefits of the layered structure on the mechanical durability of the coating, a fluorosurfactant-containing, superhydrophilic/superoleophobic coating was fabricated using a “one-pot” technique, where all the materials were mixed (at the same concentrations used in the layer-by-layer technique) and deposited together. This coating, which was found to be similar in terms of thickness and roughness as the layer-by-layer composite coating, was then subjected to the same ball-on-flat tribometer experiment as described above. The coating was found to have significantly poorer adhesion to the glass substrate than the layer-by-layer composite coating, most likely due to the presence of the low surface tension material throughout the coating instead of solely at the air interface as in the layer-by-layer composite coating.

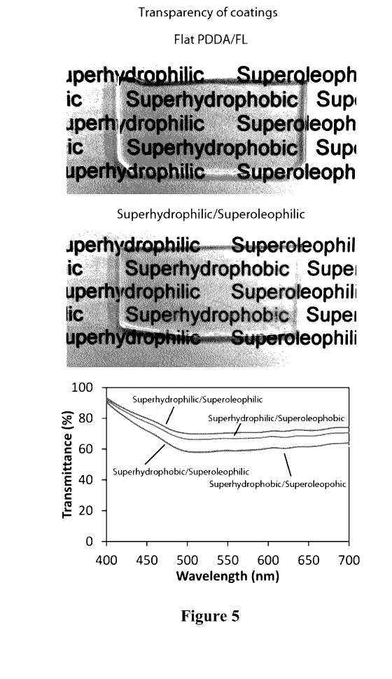

Transparency of coated samples: Many applications of self-cleaning, anti-smudge surfaces rely on the transparency of the coating. When placed directly behind the layer-by-layer composite coating sample, text remains legible, suggesting that the coating displays characteristics of transparency, as shown in FIG. 5. The transmission of visible light through the coatings was found to vary between 58-93% of that of uncoated glass depending upon the wavelength and the specific coating. The superhydrophilic/superoleophilic coating was the most transparent with transmittance of 70-93% over the visible spectrum. A level of 70% visible light transmittance is acceptable for certain automotive applications (Thomsen et al., 2005).

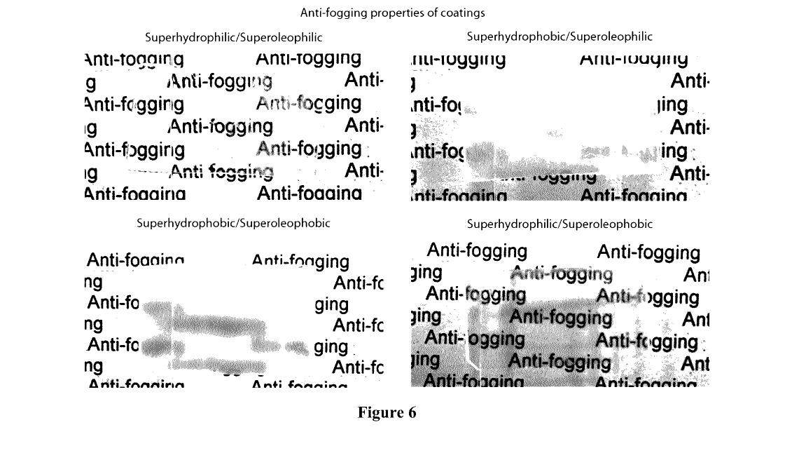

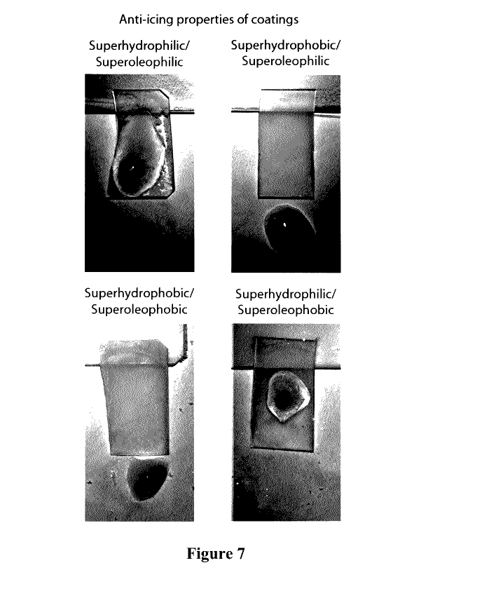

Anti-fogging property of coated samples: To examine the anti-fogging properties, all four coatings were placed directly above a source of boiling water for 5 s. The samples were then photographed to assess their transparency, shown in FIG. 6. Both the superhydrophilic coatings were found to retain their transparency with text remaining visible through the condensed water layer. In contrast, on the superhydrophobic coatings, the formation of discrete droplets of water results in samples that are completely opaque.

For the superhydrophilic/superoleophobic coating, the speed of the water penetration through the low surface tension fluorinated tail groups to the high surface tension head groups is advantageous for the condensed droplets to spread out and form a continuous water layer and thereby maintain transparency. For coatings in which the rate of water penetration is low (takes 5-30 min for surface to become superhydrophilic), these may not be suitable for anti-fogging applications.

Anti-icing property of coated samples: For anti-icing experiments, all four coatings were placed in a freezer set at −18° C. for 2 h. The samples were tilted and droplets of supercooled water were deposited onto them, as shown in FIG. 7. For the superhydrophilic coatings, the droplets spread out and froze on the sample surface. For the superhydrophobic coatings, droplets rolled off the surface to freeze on the bottom of the freezer. This occurs because the water droplets are in the Cassie-Baxter state. The formation of a composite interface minimizes the contact with the cooled substrate and ensures a low hysteresis so droplets can roll from the tilted surface. This experiment demonstrates the potential for these coatings in anti-icing applications.

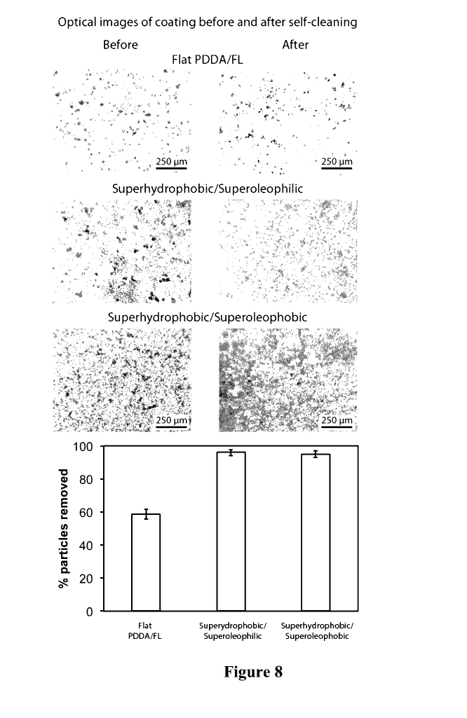

Self-cleaning property of coated samples: To examine the self-cleaning properties, the coatings were contaminated with silicon carbide particles, shown in FIG. 8. A stream of water droplets was then used to clean the surface. On the flat PDDA/FL coating this resulted in an incomplete removal of the particles with the surface remaining contaminated. For the superhydrophobic/superoleophilic and superhydrophobic/superoleophobic coatings, the vast majority of the particles were removed by the action of water droplets rolling across the repellent surfaces, collecting particles in the process. These superhydrophobic coatings self-cleaning properties may be due to their high water contact angle and low hysteresis. Water droplets deposited onto these samples are able to roll over the coating with little impediment, collecting less hydrophobic contaminants as they go.

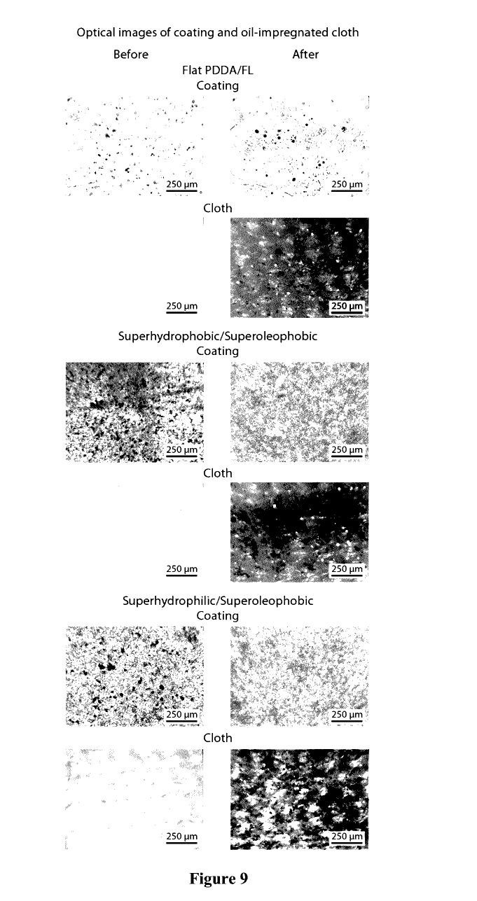

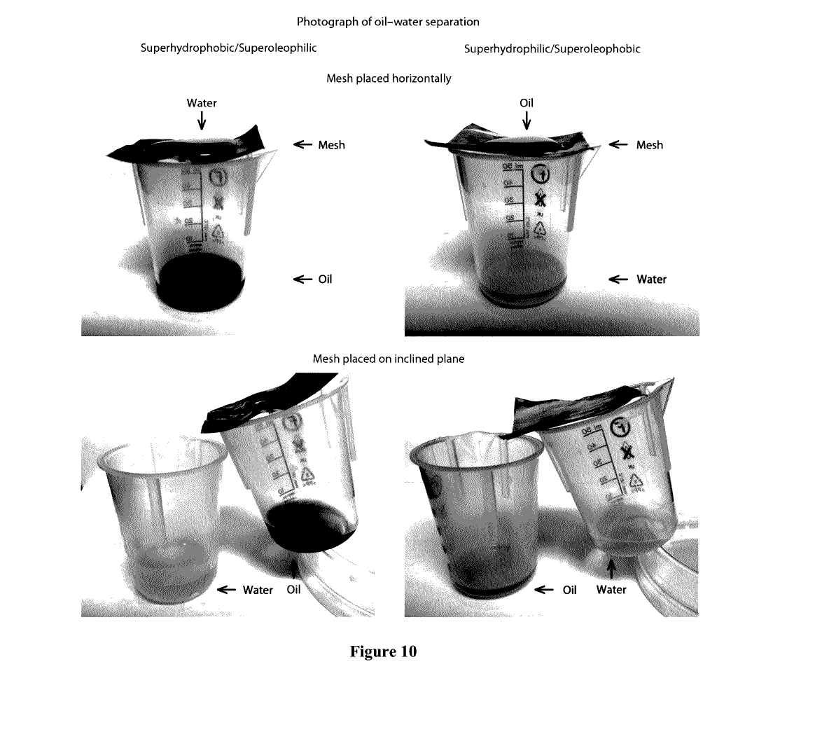

Anti-smudge property of coated samples: To examine the anti-smudge properties of the superhydrophobic/superoleophobic and superhydrophilic/superoleophobic coatings, a hexadecane-soaked cloth was used to wipe the contaminated surfaces, shown in FIG. 9. On the flat PDDA/FL coating this resulted in incomplete removal of the particles with the surface remaining contaminated. For the oil-repellent coatings, the particles were transferred to the cloth with no observable particles remaining on the surfaces. Similarly to the self-cleaning experiments with water, the anti-smudge property may be due to the high contact angle and low hysteresis for the oil. The oil in the cloth is able to collect oleophilic contaminants from the surface of the coating without sticking to the surface. Oil-water separation ability of coated samples: The superhydrophobic/superoleophilic and superhydrophilic/superoleophobic coatings exhibit different responses to water and oil and therefore are suitable for use as oil-water separators. Agitated oil-water mixtures were poured onto coated meshes suspended over beakers, as shown in FIG. 10. For the superhydrophobic/superoleophilic-coated mesh, the oil component of the mixture passed through whilst the water remained on top. Meanwhile, for the superhydrophilic/ superoleophobic-coated mesh, the opposite occurred with the water component passing through the mesh and the oil remaining on top. In both cases, the liquid remaining on top of the coated mesh could be easily removed by tilting. Placing both the meshes on an inclined plane resulted in the simultaneous collection of oil and water in two separate beakers. For the superhydrophilic/superoleophobic-coated mesh, this tilted setup is possible due to the fast penetration by water. For coatings in which the rate of water penetration is low (takes 5-30 min for surface to become superhydrophilic), these may not be suitable for this method of oil-water separation.

In both cases, the agitated mixture was effectively separated into the two component liquids. Discrete droplets (of water or oil, depending upon the coating used) of various sizes could be repelled, though the smallest droplet that it is possible to separate may be dependent upon the mesh aperture. These coatings could be applied to different materials like meshes or filters, depending upon the application, which will determine the size of oil droplets or other organic material (for instance algae or other microorganisms) that can be removed from the water. For bulk cleanup like at an oil spill, coarse separators could be used to remove the vast majority of the oil, followed downstream by finer filters to remove smaller contaminants.

Summary

A fabrication technique was been developed that can be used to create coatings with four possible combination of water and oil repellency and affinity. These coatings have been fabricated through the use of a novel combination of deposition techniques utilizing the charged layer-by-layer method for durability plus the addition of a functional layer on top for the desired surface properties. The superoleophobic coatings display oil contact angles of >150° and tilt angles <5° and the superhydrophobic coatings display water contact angles of >160° and tilt angles <2°. One coating combines both superoleophobic and superhydrophobic properties whilst others can be used to mix and match oil and water repellency and affinity.

The coatings are mechanically durable with micro- and macrowear experiments not causing any considerable damage, believed to be due to the hard SiO₂ nanoparticles and the electrostatic interaction between the base layers. Additionally, these surfaces were found to display characteristics of transparency with an averaged transmission of 75% and text remaining visible through the coating. This level of transparency is acceptable for certain automotive applications.

The applications of the coatings may be dependent upon the functional layer used. Superhydrophilic/superoleophilic coatings could find use in anti-fogging. Superhydrophobic/superoleophilic coatings could be used for self-cleaning, anti-fouling, anti-icing, and oil-water separation. The superhydrophobic/superoleophobic coating is suitable for self-cleaning, anti-fouling, anti-smudge, and anti-icing.

Finally, the superhydrophilic/superoleophobic coating could be used for anti-fouling, anti-smudge, anti-fogging, and oil-water separation. This particular coating could be useful in anti-biofouling, where superoleophobicity, superhydrophilicity and nanostructuring all contribute to reducing microorganism attachment. Additionally, when applied to a porous substrate, this coating was found to separate oil from water. These coatings, which are produced from non-toxic materials, could also help reduce the environmental impact of the gas, oil, metal, textile, and food-processing industries.

### Example 2

### Durability Test: Layer-by-Layer Technique Compared to “One-Pot” Control

The mechanical durability of coatings created by a “one-pot” technique and the layer-by-layer technique described in Example 1 was compared.

Methods

Glass slides (Fisher Scientific) were used as substrates in both cases. For the “one-pot” control, PDDA (52 mg mL⁻¹), SiO₂ NP (15 mg mL⁻¹) and fluorosurfactant (45 mg mL⁻¹) were mixed together using an ultrasonic homogenizer. This mixture was then spray coated onto the substrate and the sample was transferred to an oven operating at 140° C. for 1 h.

For the layer-by-layer coatings, four spray depositions were used. First, PDDA solution (52 mg mL⁻¹, 2 mL) was spray coated and any excess was removed from the surface via bursts of compressed air from the spray gun. Second, the Sift. NP solution (various concentrations, 3 mL) was spray coated. Third, a second PDDA layer was deposited (15 mg mL⁻¹, 1 mL). After this, the samples were transferred to an oven operating at 140° C. for 1 h. Finally, the fluorosurfactant solution (45 mg mL⁻¹, 1 mL) was spray coated and the samples were allowed to dry in air.

Macrowear experiments were performed with an established procedure of using a ball-on-flat tribometer. A sapphire ball of 3 mm diameter was fixed in a stationary holder. A load of 10 mN was applied normal to the surface, and the tribometer was put into reciprocating motion. Stroke length was 6 mm with an average linear speed of 1 mm s⁻¹. Surfaces were imaged before and after the tribometer wear experiment using an optical microscope with a CCD camera (Nikon Optihot-2) to examine any changes.

Results

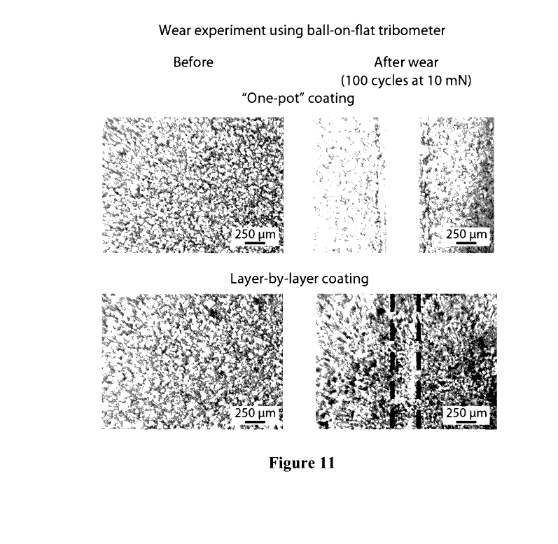

The mechanical durability of the coatings was investigated through the use of a tribometer wear experiment and the resulting images are shown in FIG. 11. The optical images show a portion of the wear track from the tribometer experiments. For the “one-pot” coating, there is significant wear with the tribometer experiment causing observable damage to the coating. In contrast, the layer-by-layer coating survived the tribometer experiment and, whilst there is some noticeable burnishing to the coating, it is minimal when compared to the damage found on the “one-pot” coating.

The “one-pot” technique results in a coating that displays very poor mechanical durability. The coating was found to be easily destroyed during a ball-on-flat tribometer wear experiment compared to the layer-by-layer coating, which exhibited minimal damage. It is believed this is due to low surface tension material being distributed throughout the coating during the “one-pot” technique resulting in poor adhesion to the substrate.

References
Antionetti, M., Henke, S. and Thünemann, A. (1996), “Highly Ordered Materials with ultra-Low Surface Energies: Polyelectrolyte-Surfactant Complexes with Fluorinated Surfactants,” Adv. Mater. 8,41-45.
Barthlott, W. and Neinhuis, C. (1997), “Purity of the sacred lotus, or escape from contamination in biological surfaces,” Planta 202, 1-8.
Bhushan, B. and Gupta, B. K. (1991), Handbook of Tribology: Materials, Coatings, and Surface Treatments, McGraw-Hill, New York.
Bhushan, B. (2011), Nanotribology and Nanomechanics I-Measurement Techniques and Nanomechanics, II-Nanotribology, Biomimetics, and Industrial Applications, 3^{rd} ed., Springer-Verlag, Heidelberg, Germany.
Bhushan, B. (2012), Biomimetics: Bioinspired Hierarchical-Structured Surfaces for Green Science and Technology, Springer-Verlag, Heidelberg, Germany.
Bhushan, B. (2013), Introduction to Tribology, 2nd ed., Wiley, N.Y.
Bhushan, B. and Muthiah, P. (2013), “Anti-smudge screening apparatus for electronic touch screens,” Microsyst. Technol. 19, 1261-1263.
Bixler, G. D. and Bhushan, B. (2015), “Rice- and Butterfly-Wing Effect Inspired Low Drag and Antifouling Surfaces: A Review,” Crit. Rev. Solid State Mat. Sci. 40, 1-37.
Bixler, G. D., Theiss, A., Bhushan, B. and Lee, S. C. (2014), “Anti-fouling properties of microstructured surfaces bio-inspired by rice leaves and butterfly wings,” J. Colloid Interf. Sci. 419, 114-133.
Brown, P. S., Atkinson, O. D. L. A. and Badyal, J. P. S. (2014) “Ultrafast Oleophobic-Hydrophilic Switching Surfaces for Antifogging, Self-Cleaning, and Oil-Water Separation,” ACS Appl. Mater. Interfaces 6, 7504-7511.
Brown, P. S. and Bhushan, B. (2015a) “Mechanically durable, superoleophobic coatings prepared by layer-by-layer technique for anti-smudge and oil-water separation,” Sci. Rep. (Nature) 5, 8701.
Brown, P. S. and Bhushan, B. (2015b) “Mechanically durable, superomniphobic coatings prepared by layer-by-layer technique for self-cleaning and anti-smudge,” Submitted. Callister, W. D. and Rethwisch, D. G. (2013), Materials Science and Engineering—An Introduction, 9^{th} ed., Wiley, N.Y.
Cao, L., Jones, A. K., Sikka, V. K., Wu, J. and Gao, D. (2009), “Anti-Icing Superhydrophobic Coatings,” Langmuir 25, 12444-12448.
Cassie, A. B. D. and Baxter, S. (1944) “Wettability of porous surfaces,” Trans. Faraday Soc. 40, 546-551.
Cebeci, F. c., Zhizhong, W., Zhai, L., Cohen, R. E., and Rubner, M. F. (2006), “Nanoporosity-Driven Superhydrophilicity: A Means to Create Multifunctional Antifogging Coatings,” Langmuir 22, 2856-2862.
Darmanin, T., Guittard, F., Amigoni, S., Tafin de Givenchy, E., Noblin, X., Kofman, R. and Celestini, F. (2011), “Superoleophobic behavior of fluorinated conductive polymer films combining electropolymerization and lithography,” Soft Matter 7, 1053-1057.
Du, X., Li, X. and He, J. (2010), “Facile Fabrication of Hierarchically Structured Silica Coatings from Hierarchically Mesoporous Silica Nanoparticles and Their Excellent Superhydrophilicity and Superhydrophobicity” ACS AppL Mater. Interfaces 2, 2365-2372. Ebert, D. and Bhushan, B. (2012), “Durable Lotus-effect surfaces with hierarchical structure using micro- and nanosized hydrophobic silica particles,” J. Colloid Inteif Sci. 368, 584-591.
Feng, L., Zhang, Z., Mai, Z., Ma, Y., Liu, B., Jiang, L. and Zhu, D. (2004), “A Super-Hydrophobic and Super-Oleophilic Coating Mesh Film for the Separation of Oil and Water,” Angew. Chem., Int. Ed. 43, 2012-2014.
Fou, A. C. and Rubner, M. F. (1995), “Molecular-Level Processing of Conjugated Polymers. 2. Layer-by-Layer Manipulation of In-Situ Polymerized p-Type Doped Conducting Polymers,” Macromolecules 28, 7115-7120.
Goddard, E. D. (1986) “Polymer-surfactant interaction. Part II. Polymer and surfactant of opposite charge,” Colloids Stuf 19, 301-329.
Grosu, G., Andrzejewski, L., Veilleux, G. and Ross G. G. (2004), “Relation between the size of fog droplets and their contact angles with CR39 surfaces,” J. Phys. D 37, 3350-3355.
Haynes, W. M. (2014), Handbook of Chemistry and Physics, 95th ed., CRC Press, Boca Raton, Fla.
He, Z., Ma, M., Lan, X., Chen, F., Wang, K., Deng, H., Zhang, Q. and Fu, Q. (2011), “Fabrication of a transparent superamphiphobic coating with improved stability,” Soft Matter 7, 6435-6443.
Hsieh, C.-T., Chen, J.-M., Kuo, R.-R., Lin, T.-S. and Wu, C.-F. (2005), “Influence of surface roughness on water- and oil-repellent surfaces coated with nanoparticles,” Appl. Surf. Sci. 240, 318-326.
Hutton, S. J., Crowther, J. M. and Badyal, J. P. S. (2000), “Complexation of Fluorosurfactants to Functionalized Solid Surfaces: Smart Behavior,” Chem. Mater. 12, 2282-2286.
Jin, H., Tian, X., Ikkala, O. and Ras, R. H. A. (2013), “Preservation of superhydrophobic and superoleophobic properties upon wear damage,” ACS Appl. Mater. Interfaces 5, 485-488.
Jung, Y. C. and Bhushan, B. (2009), “Wetting behavior of water and oil droplets in three-phase interfaces for hydrophobicity/philicity and oleophobicity/philicity,” Langmuir 25, 14165-14173.
Lampitt, R. A., Crowther, J. M. and Badyal, J. P. S. (2000), “Switching Liquid Repellent Surfaces,” J. Phys. Chem. B 104, 10329-10331.
Lee, C. H., Johnson, N., Drelich, J. and Yap, Y. K. (2011), “The performance of superhydrophobic and superoleophilic carbon nanotube meshes in water-oil filtration,” Carbon 49, 669-676.
Lee, K. K. and Ahn, C. H. (2013), “Superhydrophilic Multilayer Silica Nanoparticle Networks on a Polymer Microchannel Using a Spray Layer-by-Layer Nanoassembly Method” ACS Applied Mater. Interfaces 5, 8523-8530.
Li, L., Wang, Y., Gallaschun, C., Risch, T. and Sun, J. (2012), “Why can a nanometer-thick polymer coated surface be more wettable to water than to oil?” J. Mater. Chem. 22, 16719-1672.
Liu, X. and He, J. (2009), “Superhydrophilic and Antireflective Properties of Silica Nanoparticle Coatings Fabricated via Layer-by-Layer Assembly and Postcalcination,” J. Phys. Chem. C 113, 148-152.
Lvov, Y., Ariga, K., Onda, M., Ichinose, I. and Kunitake, T. (1997), “Alternate Assembly of Ordered Multilayers of SiO₂ and Other Nanoparticles and Polyions,” Langmuir 13, 6195-6203.
Kulinich, S. A. and Farzaneh, M. (2009), “Ice adhesion on super-hydrophobic surfaces,” Appl. Surf Sci. 255, 8153-8157.
Nishimoto, S. and Bhushan, B. (2013), “Bioinspired Self-cleaning Surfaces with Superhydrophobicity, Superoleophobicity, and Superhydrophilicity,” RSC Advances 3, 671-690.
Onda, M., Lvov, Y., Ariga, K. and Kunitake, T. (1996), “Sequential Reaction and Product Separation on Molecular Films of Glucoamylase and Glucose Oxidase Assembled on an Ultrafilter,” J. Ferment. Bioeng. 82, 502-506.
Pan, S., Kota, A. K., Mabry, J. M. and Tuteja, A. (2013), “Superomniphobic Surfaces for Effective Chemical Shielding,” J. Am. Chem. Soc. 135, 578-581.
Park, I., Efimenko, K., Sjöblom, J. and Genzer, J. (2009), “Rapid Removal of Organics and Oil Spills from Waters Using Silicone Rubber “Sponges”,” J. Disper. Sci. Technol. 30, 318-327.
Park, J. T., Seo, J. A., Ahn, S. H., Kim, J. H., Kang, S. W. (2010), “Surface modification of silica nanoparticles with hydrophilic polymers,” J. Ind. Chem. Eng. 16, 517-522. Podsiadlo, P. (2008), Layer-by-layer Assembly of Nanostructured Composites: Mechanics and Applications, Ph.D. Thesis, University of Michigan, Ann Arbor, Mich.
Saito, T., Tsushima, Y. and Sawada, H. (2015), “Facile creation of superoleophobic and superhydrophilic surface by using fluoroalkyl end-capped vinyltrimethoxysilane oligomer/calcium silicide nanocomposites—development of these nanocomposites to environmental cyclical type-fluorine recycle through formation of calcium fluoride,” Colloid Polym. Sci. 293, 65-73.
Sawada, H., Ikematsu, Y., Kawase, T., Hayakawa, Y. (1996), “Synthesis and Surface Properties of Novel Fluoroalkylated Flip-Flop-Type Silane Coupling Agents,” Langmuir 12, 3529-3530.
Sawada, H., Yoshioka, H., Kawase, T., Takahashi, H., Abe, A. and Ohashi, R. (2005), “Synthesis and Applications of a Variety of Fluoroalkyl End-Capped Oligomers/Silica Gel Polymer Hybrids,” J. Appl. Polym. Sci. 98, 169-177.
Thomsen, S. V., Hulme, R., Landa, L. & Landa, K., “High visible transmission and infrared/ultraviolet radiation absorption; for automotive windows (windshields, sidelites, backlites and sunroofs) and in architectural windows,” US Patent 20050020430 A1, 27 Jan. 2005.
Thünemann, A. F. and Lochhaas, K. H. (1999), “Surface and Solid-State Properties of a Fluorinated Polyelectrolyte-Surfactant Complex,” Langmuir 15, 4867-4874.
Tuteja, A., Choi, W., Ma, M., Mabry, J. M., Mazzella, S. A., Rutledge, G. C., McKinley, G. H. and Cohen, R. E. (2007), “Designing Superoleophobic Surfaces,” Science 318, 1618-1622.
Wang, S., Li, M. and Lu, Q. (2010), “Filter Paper with Selective Absorption and Separation of Liquids That Differ in Surface Tension,” ACS AppL Mater. Interfaces 2, 677-683.
Wang, Y., Xue, J., Wang, Q., Chen, Q. and Ding, J. (2013), “Verification of Icephobic/Anti-icing Properties of a Superhydrophobic Surface,” ACS Appl. Mater. Interfaces 5, 3370-3381.
Wang, Y. and Bhushan, B. (2015), “Wear-Resistant and Antismudge Superoleophobic Coating on Polyethylene Terephthalate Substrate Using SiO₂Nanoparticles,”ACS Appl. Mater. Interfaces 7, 743-755.
Wenzel, R. N. (1936), “Resistance of Solid Surfaces to Wetting by Water,” Ind. Eng. Chem. 28, 988-994.
Xie, Y., Hill, C. A. S., Xiao, Z., Militz, H. and Mai, C. (2010) “Silane coupling agents used for natural fiber/polymer composites: A review,” Composites: Part A 41, 806-819.
Yang, S., Xia, Q., Zhu, L., Xue, J., Wang, Q., Chen, Q. (2011a), “Research on the icephobic properties of fluoropolymer-based materials,” Appl. Surf Sci. 257, 4956-4962.
Yang, J., Zhang, Z., Men, X., Xu, X., Zhu, X. (2011b), “A simple approach to fabricate superoleophobic coatings,” New J. Chem. 35, 576-580.
Yang, J., Zhang, Z., Xu, X., Zhu, X., Men, X., Zhou, X. (2012), “Superhydrophilic-superoleophobic coatings” J. Mater. Chem. 22, 2834-2837.
Young, T. (1805), “An Essay on the Cohesion of Fluids,” Philos. Trans. R. Soc. 95, 65-87.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative materials and method steps disclosed herein are specifically described, other combinations of the materials and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments and are also disclosed. As used in this disclosure and in the appended claims, the singular forms “a”, “an”, “the”, include plural referents unless the context clearly dictates otherwise.

What is claimed is:

1. A multilayer coating comprising a plurality of layers haying alternating charge, the plurality of layers comprising:
a. two or more base layers, the two or more base layers comprising,
i. a fixed layer comprising a first polymer haying a charge,
ii. an inorganic layer comprising a plurality of particles haying a charge;
b. an adhesion layer disposed on the two or more base layers, the adhesion layer comprising a second polymer haying a charge; and
c. a functional layer disposed on the adhesion layer, wherein the functional layer forms a surface of the multilayer coating.

2. The multilayer coating of claim 1, wherein the adhesion layer is disposed on the inorganic layer.

3. The multilayer coating of claim 1, wherein the first polymer has a charge opposite that of the plurality of particles, and wherein the second polymer has a charge opposite that of the plurality of particles.

4. The multilayer coating of claim 1, wherein the multilayer coating comprises
a. a fixed layer comprising a first polymer haying a charge;
b. an inorganic layer disposed on the fixed layer, the inorganic layer comprising a plurality of particles haying a charge opposite that of the first polymer;
c. an adhesion layer disposed on the inorganic layer, the adhesion layer comprising a second polymer haying a charge opposite that of the plurality of particles; and
d. a functional layer disposed on the adhesion layer, wherein the functional layer forms a surface of the multilayer coating.

5. The multilayer coating of claim 1, wherein the charge density of the first polymer is from about 1.0 to about 20 meq/g, and the charge density of the second polymer is from about 1.0 to about 20 meq/g.

6. The multilayer coating of claim 1, wherein the first polymer is a cationic polymer and the second polymer is a cationic polymer.

7. The multilayer coating of claim 1, wherein the plurality of particles comprise a plurality of anionic particles.

8. The multilayer coating of claim 1, wherein the plurality of particles comprises a plurality of nanotubes, a plurality of nanoparticles, or a combination thereof.

9. The multilayer coating of claim 1, wherein the functional layer comprises a superoleophilic material, a superoleophobic material, a superhydrophobic material, a superhydrophilic material, or combinations thereof.

10. The multilayer coating of claim 1, wherein the functional layer is patterned.

11. The multilayer coating of claim 1, wherein the functional layer comprises a halogenated silane, a fluorosurfactant, or a combination thereof.

12. The multilayer coating of claim 1, wherein the multilayer coating has a thickness of from about 100 nm to about 800 nm.

13. The multilayer coating of claim 1, wherein the surface of the multilayer coating exhibits a water contact angle of at least about 150° and a hexadecane contact angle of at least about 150°.

14. The multilayer coating of claim 1, wherein the surface of the multilayer coating exhibits a water contact angle of less than about 10° and a hexadecane contact angle of at least about 150°.

15. The multilayer coating of claim 1, wherein the surface of the multilayer coating exhibits a water contact angle of less than about 10° and a hexadecane contact angle of less than about 10°.

16. The multilayer coating of claim 1, wherein the surface of the multilayer coating exhibits a tilt angle of from about 2° to about 10°.

17. A coated article comprising the multilayer coating of claim 1, wherein the article comprises a mesh comprising the multilayer coating of claim 1.

18. A method of forming a multilayer coating on a substrate, comprising:
a. depositing two or more base layers haying alternating charge on a surface of the substrate, the two or more base layers comprising,
i. a fixed layer comprising a first polymer haying a charge,
ii. an inorganic layer comprising a plurality of particles haying a charge;
b. depositing a second polymer haying a charge on the two or more base layers to form an adhesion layer; and
c. depositing a functional material on the adhesion layer to form a functional layer disposed on the adhesion layer.

19. The method of claim 18, comprising:
a. depositing a first polymer haying a charge on a surface of the substrate to form a fixed layer disposed on the substrate;
b. depositing a plurality of particles haying a charge opposite that of the first polymer on the fixed layer to form an inorganic layer disposed on the fixed layer;
c. depositing a second polymer haying a charge opposite that of the plurality of particles on the inorganic layer to form an adhesion layer disposed on the inorganic layer; and
d. depositing a functional material on the adhesion layer to form a functional layer disposed on the adhesion layer.

20. A method of separating a liquid mixture comprising a polar liquid and a non-polar liquid, the method comprising contacting the article of claim 17 with the liquid mixture under conditions effective to afford permeation of the polar liquid or the non-polar liquid through the article.
